(19) United States
(12) Patent Application Publication
(10) Pub. No.: US 2026/0204927 A1
(43) Pub. Date: Jul. 16, 2026

(54) CHARGING AND DISCHARGING SYSTEM

(71) Applicant: NYOBOLT LIMITED, Impington, Cambrodge, Cambs (GB)

(72) Inventors: Mahesh DE SILVA, Cambridge (GB); James Hoyle, Cambridge (GB)

(21) Appl. No.: 19/130,813

(22) PCT Filed: Nov. 21, 2023
(86) PCT No.: PCT/EP2023/082593

§ 371 Date: May 16, 2025

(30) Foreign Application Priority Data
Nov. 21, 2022 (GB) 2217380.1

(51) Int. Cl. H02J 7/00; H01M 10/44; H02J 7/04; H02J 7/34; H02J 7/44; H02J 7/52

(52) U.S. Cl. CPC H02J 7/485; H01M 10/441; H02J 7/04; H02J 7/342; H02J 7/44; H02J 7/52; H02J 7/855; H02J 2207/20

(57) ABSTRACT

The invention relates to a method and system for charging multiple batteries to a load or charging multiple batteries from a source, and a use of the system. The system comprises two or more batteries wherein two of the batteries have one or more different aspects; a power connector for electrically connecting the batteries to a load or a source; a power converter in electrical communication with the batteries and the power connector, wherein the power converter is for independently controlling the rate of discharge or charge of each of the batteries; and a controller in communication with the batteries and the power converter, wherein the controller is for adjusting the rate of discharge or charge of the batteries in response to data receivable from the batteries, for providing a constant power from the batteries to the load, or from the source to the batteries.

### RELATED APPLICATION

The present case claims priority to, and benefit of, GB 2217380.1 filed on 21 Nov. 2022 (21 Nov. 2022), the contents of which are hereby incorporated by reference in their entirety.

### FIELD OF THE INVENTION

The present invention relates to a system for charging multiple batteries to a load or charging multiple batteries from a source, a method of charging and discharging the system and a use of the system for charging or discharging two or more batteries.

### BACKGROUND

There is currently a wide variety of battery technologies involving different chemical reactions, different physical properties or different cycling conditions. This results in batteries having different electrical properties.

For example, a battery cell incorporating a working electrode comprising niobium tungsten oxide such as that disclosed in Grey et al (WO 2019/234248) can be charged at a very high rate, has a wide voltage range and steep discharge voltage profile. In contrast, a battery cell with a working electrode primarily composed of graphite has a higher capacity, cannot be charged at such a high rate, and has a narrower voltage range and a flatter discharge voltage profile. Another example is first-life batteries (which are new and have not been extensively cycled) compared to second-life batteries (which have been extensively cycled). The second-life batteries will have undergone some degradation, and so will have a different voltage range and voltage profile compared to the first-life batteries.

It is difficult to include batteries having different electrical properties in a single system such as a single power source. It is particularly difficult to include batteries having different cell chemistries in a single system where the different batteries discharge or charge simultaneously. In known systems including multiple batteries, the systems selectively connect only one or the other of the batteries, and the batteries cannot be used simultaneously. As a result, the power in or out of the system is not constant.

Accordingly, there is a need for systems which can charge and/or discharge different batteries, in particular batteries having different electrical properties.

### SUMMARY OF THE INVENTION

At its most general, the invention provides a system for discharging two or more different batteries to a load, or charging two or more different batteries from a source, wherein a power converter independently controls the rate of discharging or charging of the batteries to provide a constant power from the batteries to the load or a constant power from the source to the batteries.

In one general aspect the invention provides a system for discharging two or more different batteries to a load, wherein a power converter independently controls the rate of discharging of the batteries to provide a constant power from the batteries to the load.

In one general aspect, the invention provides a system for charging two or more different batteries from a source, wherein a power converter independently controls the rate of charging of the batteries to provide a constant power from the source to the batteries.

In a first aspect of the invention there is provided a system for discharging multiple batteries to a load, or charging multiple batteries from a source, the system comprising:
two or more batteries wherein two of the batteries have one or more different aspects;
a power connector for electrically connecting the batteries to a load or a source;
a power converter in electrical communication with the batteries and the power connector, wherein the power converter is for independently controlling the rate of discharge or charge of each of the batteries; and
a controller in communication with the batteries and the power converter, wherein the controller is for adjusting the rate of discharge or charge of the batteries in response to data receivable from the batteries, for providing a constant power from the batteries to the load, or from the source to the batteries.

In a related aspect, the invention provides a system for discharging multiple batteries to a load, the system comprising:
two or more batteries wherein two of the batteries have one or more different aspects;
a power connector for electrically connecting the batteries to a load;
a power converter in electrical communication with the batteries and the power connector, wherein the power converter is for independently controlling the rate of discharge of each of the batteries; and
a controller in communication with the batteries and the power converter, wherein the controller is for adjusting the rate of discharge of the batteries in response to data receivable from the batteries, for providing a constant power from the batteries to the load.

In another aspect, the invention provides a system for charging multiple batteries from a source, the system comprising:
two or more batteries wherein two of the batteries have one or more different aspects;
a power connector for electrically connecting the batteries to a source;
a power converter in electrical communication with the batteries and the power connector, wherein the power converter is for independently controlling the rate of charge of each of the batteries; and
a controller in communication with the batteries and the power converter, wherein the controller is for adjusting the rate of charge of the batteries in response to data receivable from the batteries, for providing a constant power from the source to the batteries.

Typically, the system is for simultaneously discharging two or more batteries having one or more different aspects to a load, or simultaneously charging two or more batteries having one or more different aspects from a source.

Preferably, the controller is for simultaneously controlling the rate of discharge or charge of each of the two or more batteries, wherein two or more of the batteries have one or more different aspects.

Generally, the invention also provides a method of charging or discharging two or more different batteries from a source or to a load, the method comprising adjusting the rate of charging or discharging of the batteries in response to data from the batteries, to provide a constant power from the batteries to the load or from the source to the batteries.

In a second aspect of the invention there is provided a method of discharging multiple batteries to a load, or charging multiple batteries from a source, using a system comprising:
two or more batteries wherein two of the batteries have one or more different aspects;
a power connector electrically connecting the batteries to the load or the source;
a power converter in electrical communication with the batteries and the power connector, wherein the power converter independently controls the rate of discharge or charge of each of the batteries; and
a controller in communication with the batteries and the power converter, and the method comprising the steps of:
discharging the batteries to the load, or charging the batteries from the source, using the power converter and power connector,
sending data on the condition of the batteries to the controller, and
adjusting the discharge rate or the charge rate of the batteries in response to the data from the batteries, to provide a constant power from the batteries to the load or from the source to the batteries.

In a related aspect there is provided a method of discharging multiple batteries to a load using a system comprising:
two or more batteries wherein two of the batteries have one or more different aspects;
a power connector electrically connecting the batteries to the load;
a power converter in electrical communication with the batteries and the power connector, wherein the power converter independently controls the rate of discharge of each of the batteries; and
a controller in communication with the batteries and the power converter, and the method comprising the steps of:
discharging the batteries to the load, using the power converter and power connector,
sending data on the condition of the batteries to the controller, and
adjusting the discharge rate of the batteries in response to the data from the batteries, to provide a constant power from the batteries to the load.

In another aspect there is provided a method of charging multiple batteries from a source, using a system comprising:
two or more batteries wherein two of the batteries have one or more different aspects;
a power connector electrically connecting the batteries to the source;
a power converter in electrical communication with the batteries and the power connector, wherein the power converter independently controls the rate of charge of each of the batteries; and
a controller in communication with the batteries and the power converter, and the method comprising the steps of:
charging the batteries from the source using the power converter and power connector,
sending data on the condition of the batteries to the controller, and
adjusting the charge rate of the batteries in response to the data from the batteries, to provide a constant power from the source to the batteries.

Typically, the method comprises simultaneously discharging two or more batteries having one or more different aspects to a load, or simultaneously charging two or more batteries having one or more different aspects from a source, wherein the method comprises adjusting the discharge rate or charge rate of the two or more batteries to provide constant power from the source or to the load from the two or more batteries.

In a third aspect there is provided a use of the system of the first aspect for discharging the two or more batteries to a load or charging the two or more batteries from a source.

In a related aspect, there is provided a use of the system of the first aspect for discharging the two or more batteries.

In another aspect, there is provided a use of the system of the first aspect for charging the two or more batteries.

Including a system having two or more batteries with different cell chemistries is advantageous. The different properties of the batteries allow the system to select different types of battery cell for different applications, which is beneficial to system performance. However, different types of battery cells have different requirements for power electronics such as operating voltage range, voltage profile, and charge/discharge current levels. In order to address this problem, the present invention uses a power conversion and controller that manages power flow to and from different batteries and enables unbalanced current demands across different sources to suit their charge/discharge properties.

The invention allows for coupling of multiple batteries to a common input or output for the purpose of charging or discharging. The power converter operates to provide a constant power to or from the multiple batteries. For example, the power converter may provide a constant voltage or constant current to or from the multiple batteries to result in a stable input or output.

The system of the invention allows a variety of discharge or charge rates to be achieved by a single system, while maintaining high efficiency of the system. Some types of battery are adapted to charge/discharge at high rates. These high-rate cells may be expensive and may have a lower storage capacity (e.g. gravimetric or volumetric energy density) than lower rate cells. Other types of battery are adapted to charge/discharge at low rates. These low-rate cells are often cheaper, have good coulombic efficiency and high capacity. It can therefore be advantageous to include both high-rate and low-rate batteries in a battery system. The high-rate battery is able to provide high power to meet high load demands or receive high power supplied from a source. The low-rate battery is able to provide high capacity and high efficiency energy storage.

The present invention thus also provides a system where both high-rate and low-rate batteries can be included in one system. The system controls which of the different batteries is charged or discharged depending on the power source or load demanded of the system. The system also maintains the conditions of the different batteries within an acceptable range, to ensure safe discharging and charging. This also improves the longevity of the different types of cells.

The system also protects the load, by managing the charge delivered from the batteries to meet the demands of the load. Some loads (e.g. devices) are sensitive to high current or high voltage, and the present invention prevents high current or voltage discharge to such loads. Some loads are sensitive to voltage fluctuation and similar sources of noise. The system smooths out such fluctuation and noise. For example, fluctuation may negatively affect the efficiency of motors; a motor's speed will reduce as the voltage of its power supply decreases and increase as the voltage increases, leading to increased power use to compensate for the deceleration.

This invention is beneficial because it allows the power converter to manage power flow to and from each battery, while also incorporating a central controller which manages unbalanced power demands across different sources to suit their discharge rating. Without a system such as that disclosed herein, such unbalanced demand would be potentially unsafe, as it might lead to overcharge or over-discharge of some batteries while undercharging or under-discharging other batteries.

For example, in a system of the invention it would be possible to combine a low discharge speed, high-capacity battery with a high discharge speed, low-capacity battery for optimised performance. Different cell chemistries have different characteristics, so it is advantageous to use circuitry and converters to standardise output from a storage device that contains cells of different chemistries.

The system also makes it possible to combine a second-life batteries having relatively poor electrochemical properties with first-life batteries having relatively good electrochemical properties. In such a system a degraded second-life battery can be used as the low-rate battery while the undegraded first-life battery can be used as the high rate battery. Such a system allows for extended use of second-life batteries and allows for smaller first-life batteries to be used, without compromising system performance.

The power converters manage power flow and enable unbalanced current demands across sources to suit their discharge rating. This enables low rate, high capacity and high rate, lower capacity batteries to be coupled for optimised drive cycle usage and performance. Optimal power source selection allows the system to run in high efficiency regions across wider ranges and enhances product life expectancy due to managed battery and component stress.

For example, in a conventional one-battery system a single battery must cope with peaks in the load or supply of power, and so the battery will be forced to operate outside of its preferred operating parameters (e.g. at high rates). This will accelerate degradation of the battery. The present invention allows for different batteries to be used, so for example a high-rate battery can be used to deliver peak loads or receive peak supply meaning the low-rate battery does not need to operate outside of its preferred operating parameters. This prolongs battery life by limiting degradation.

In some embodiments of the invention, the controller balances the different batteries by independently adjusting the discharge or charge rate of the two or more of the batteries, and/or by transferring power between the two or more batteries. Balancing the batteries results in the different batteries operating in their optimal state of charge (SOC), which prolongs battery lifetime and improves charging/discharging efficiency. Balancing the batteries also means the different batteries have capacity to accept further power during charging and capacity to provide power during discharging.

For example, where a high-rate and low-rate battery are used, this allows the system to be read to deliver and receive both high-rates and low-rates of power and use the optimal battery to deliver and receive this power. In contrast, if the high-rate and low-rate batteries are not balanced, the high-rate battery may end up with a high SOC and the low-rate battery may end up with a low SOC following a period of fast charging. If the system then needs to receive further fast charging, the high-rate battery has limited capacity to accept the fast charging so the low-rate battery may need to be used under sub-optimal conditions. Similarly, if the system needs to deliver a slow discharge, the low-rate battery may have limited capacity to deliver the slow discharge so the high-rate battery may need to be used under sub-optimal conditions. Balancing the SOC of the high-rate and low-rate batteries means the system is able to deliver and receive power at a range of rates using the optimal batteries, meaning the charging and discharging is more efficient.

### SUMMARY OF THE FIGURES

The present invention is described with reference to the figures listed below.

FIG. 1 shows a block circuit diagram of an example system according to an embodiment of the invention, including three batteries and three associated power converters.

FIG. 2 shows a flowchart of an example control algorithm for controlling the power converters to adjust the rate of charge or discharge of the two or more batteries.

FIG. 3 shows the results of a simulation of regularisation of output voltage of a two-battery system, where the two batteries having different output voltages. [31] shows the input voltage of the two batteries before any power conversion. [32] shows the voltage of the output of each of the two power converters. [33] shows the voltage of the output of both power converters combined together from the output bus. [34] shows the ratio of contributions from the two power converters.

FIG. 4 shows the results of a simulation which shows improved output power consistency to a load with a varying demand over time. [41] shows the input voltage to the converters, i.e. the output voltage from the two batteries. [44] shows the ratio of contributions from the two power converters. [43] shows the voltage output by the two power converters. [45] shows the changes in demand from the load [13], together with the thresholds used to trigger the controller [15] to activate one battery (and the corresponding power converter). The demand is shown by the solid line labelled in the key as “Power Controller Duty Cycle: 1”. The thresholds are shown by the two dashed lines of which the upper threshold is labelled in the key as “Power Controller Duty Cycle: 2” and the lower threshold is labelled in the key as “Power Controller Duty Cycle: 3”.

FIG. 5 shows the results of a simulation of regularisation of charging of a two battery system, the two batteries having different cell chemistries. [51] shows the input voltage of the source into the system before any power conversion. [52] shows the voltage of the output of each of the two power converters, and [53] the output voltage into the two batteries. [54] shows the ratio of contributions of the voltage from the two power converters to each of the two batteries.

FIG. 6 is a diagram of an example controller structure for a system including ‘n’ different batteries for discharging the n batteries to a load.

FIG. 7 is a diagram of an example controller structure for a system including ‘n’ different batteries for charging the n batteries from a source.

FIG. 8 shows a flowchart of an example control algorithm for controlling the power converters to adjust the rate of discharge of the two or more batteries, including wherein the batteries are balanced by actively transferring power between the batteries or by adjusting the power transfer to the load.

FIG. 9 shows a flowchart of an example control algorithm for controlling the power converters to adjust the rate of charge of the two or more batteries including wherein the batteries are balanced by adjusting the power transferred to the batteries from the source.

### DETAILED DESCRIPTION OF THE INVENTION

The present invention provides a system for charging or discharging two or more different batteries to a load or from a source, wherein a power converter independently controls the rate of charging or discharging of the batteries to provide a constant power from the batteries to the load or to provide a constant power from the source to the batteries. The system may divide the power demand between the batteries or divide the power supply between the batteries.

The invention also provides a method of charging or discharging two or more different batteries from a source or to a load, the method comprising adjusting the rate of charging or discharging of the batteries in response to data from the batteries, to provide a constant power from the batteries to the load or to provide a constant power from the source to the batteries.

Some systems for charging or discharging two or more batteries are known.

WO 2015/016965 relates to a dual-chemistry battery module in an electric vehicle (EV) which may include a controller which can selectively connect one or the other of two battery cells to the EV systems. The battery cells cannot be used simultaneously since the control mechanism is based on switching discretely between the different batteries. This differs from the present invention wherein the two or more batteries may be discharged simultaneously to provide a constant power to the load or may be charged simultaneously to optimise charging from the source. The coordinated simultaneous charging or discharging of the different batteries results in improved battery utilisation and efficiency. This is not disclosed in WO 2015/016965

US 2005/0194937 concerns a system with multiple batteries each connected to a converter, the converters being connected in series to allow current to flow through the converters even if a battery is inactive or disconnected. This system is designed to avoid the problems that can arise when batteries are connected in series and one battery fails. The system allows for the converter to selectively bypass the failed battery. US 2005/0194937 does not relate to a system including different batteries and does not simultaneously discharge different batteries.

Instead, US 2005/0194937 solves an entirely different problem of allowing for failure of a single battery in a battery system.

In addition, US 2004/0169489 and US 2006/0028178 both describe electric vehicle chargers, which are said to automatically charge at the correct battery voltage for various types of batteries. The documents do not describe discharging of batteries. The documents also do not describe a system where two or more different batteries are charged, and where a power converter independently controls the charge rate of the two or more different batteries. US 2004/0169489 and US 2006/0028178 describe a system which may control power delivery for different batteries individually—but different batteries are not charged or discharged simultaneously. The documents explain that the power supply provides a relatively constant power to the battery, but the control of two different types of batteries to provide a constant power is not described.

Additionally, WO 2016/054368 and WO 2016/054359 both describe battery charging systems designed to accommodate different types of batteries. The documents do not describe discharging of batteries. WO 2016/054359 only describes a system which can charge one battery at a time, and so is not relevant to the system and method of the present invention which relates to charging or discharging two or more different batteries. WO 2016/054368 describes a charger for multiple batteries, where different outputs can accommodate different batteries. However, WO 2016/054368 does not describe a system or method which provides or receives a constant power to/from the different batteries. The different batteries are not charged or discharged simultaneously to provide a constant power.

WO 2020/086946 relates to an electric drive system for an electric vehicle, including two batteries having different chemistries which power a drive motor. The document does not describe a system or method which controls the power charged or discharged from the batteries simultaneously, such that a constant power flows to/from the different batteries. WO 2020/086946 also does not describe a method of balancing the batteries in the system.

The known systems do not describe systems or methods relating to simultaneous charging or discharging of multiple different batteries, to provide or receive constant power. The systems also do not relate to batteries providing high charge or discharge rates, and the preferred battery chemistries of the present invention are also not described.

### System

The invention provides a system for discharging multiple batteries to a load, or charging multiple batteries from a source, the system comprising:
two or more batteries wherein two of the batteries have one or more different aspects;
a power connector for electrically connecting the batteries to a load or a source;
a power converter in electrical communication with the batteries and the power connector, wherein the power converter is for independently controlling the rate of discharge or charge of each of the batteries; and
a controller in communication with the batteries and the power converter, wherein the controller is for adjusting the rate of discharge or charge of the batteries in response to data receivable from the batteries, for providing a constant power from the batteries to the load, or from the source to the batteries.

The system may be used for discharging multiple batteries to a load. The system may be used for charging multiple batteries from a source. In some embodiments, the system may be able to discharge and charge multiple batteries.

The load is preferably a single load. The load may be an electronic device. The load may include multiple electronic devices. Preferably, the load is a single device. In this case, the power from the multiple batteries is converged into power for a single device.

The source is preferably a single source. The source may be a power supply. The source may include multiple power supplies but is preferably a single power supply. In this case, the power from the single power supply is diverged to power the multiple batteries.

In the system, the two or more batteries are in electrical communication with the power converter. The power converter is in electrical communication with the power connector.

Preferably, the two or more batteries are in electrical communication with the power connector via the power converter.

In additional embodiments, the two or more batteries are in electrical communication, preferably in direct electrical communication. Typically at least two of the different batteries are in electrical communication, and preferably all of the two or more batteries are in electrical communication. Preferably at least a high-rate battery and a low-rate battery are electrically connected. An electrical connection between the two or more batteries allows for battery balancing by a transfer of power between the two or more batteries.

The two or more batteries may be in electrical communication via a power converter, wherein the power converter is in communication with the controller. The controller is for controlling the power converter to control the rate of power transfer between the two or more batteries. The controller may adjust the rate of power transfer between the two or more batteries to balance the batteries, as described in the Controller section herein.

Electrical communication in this context may refer to a connection which allows for transfer of electrical energy. Typically, electrical communication is provided by a conducting wire (e.g. a copper or aluminium wire).

In the system, the controller is in communication with the two or more batteries and the power converter. The controller may also be in communication with an input or output monitor. The input monitor is operable to monitor the input power to the system from a source. The output monitor is operable to monitor the output power from the system to a load.

Communication in this context may refer to any connection which allows for the transfer of a signal or information, such as data. This may include wired or wireless communication.

The system provides a constant power from the two or more batteries to the load. The system is operable to provide a constant power from the two or more batteries to the load. That is, the output power to the load is constant during the operation period of the system. A constant power is desirable for reliable and safe operation of an electrical device (e.g. the load).

The system provides a constant power from the power source to the two or more batteries. The system is operable to provide a constant power from the source to the two or more batteries. That is, the input power to the two or more batteries is constant during the operation period of the system. A constant power is required for reliable and safe charging of the two or more batteries.

A constant power is typically a power which is continuous over a period of time, such as over the operational period of the system. A constant power preferably is substantially the same over the operation period of the system A constant power preferably does not include any significant variation over the operation period of the system. A constant power is suitable for the present invention if it does not materially vary over time during the systems operation.

The operation period of the system is typically the time period from starting charging or discharging to stopping charging or discharging.

A constant power may be quantified as a power which differs by ±20% or less from the mean power taken over the operation period of the system, and preferably ±15% or less, more preferably ±10% or less, even more preferably ±5% or less. In other words, if the mean power is 1 kW and the power differs by ±20% or less (e.g. ±0.2 kW or less), then the constant power is from 0.8 kW to 1.2 kW.

A constant power may also be a power which is constant relative to the power demand of the load or the power supply from the source. A constant power preferably refers to a power which is substantially the same as the power demanded by the load or supplied by the source. In this case, the constant power may be quantified as a power which differs by ±20% or less from the mean power taken from the power demand of the load or the power supply from the source, and preferably ±15% or less, more preferably ±10% or less, even more preferably ±5% or less. In other words, if the power demand of the load or the power supply from the source is 1 kW and the power differs by ±20% or less (e.g. ±0.2 kW or less), then the constant power is from 0.8 kW to 1.2 kW.

During discharging, a constant power may also be quantified as a power which differs by ±20% or less from the power demand of the system, and preferably ±15% or less, more preferably ±10% or less, even more preferably ±5% or less.

During charging, a constant power may also be quantified as a power which differs by ±20% or less from the power source, preferably ±15% or less, more preferably ±10% or less, even more preferably ±5% or less.

Alternatively, a constant power may be defined as a power which has a rate of change of power of ±100 W/s or less, preferably ±50 W/s or less, more preferably ±20 W/s or less, even more preferably ±10 W/s or less.

A constant power may also be defined as a power which has a rate of divergence from the power demand of the load or the power supply from the source of ±100 W/s or less, preferably ±50 W/s or less, more preferably ±20 W/s or less, even more preferably ±10 W/s or less.

### Batteries

A battery may comprise one or more electrochemical cells. A battery may also comprise any other electrical storage device such as a flow cell, fuel cell or capacitor. The batteries typically are rechargeable electrical storage devices.

The system comprises two or more batteries, wherein two of the batteries are different. Generally, two of the batteries are different if they have one or more different aspects.

The different aspects may include different electrical properties, chemical properties, physical properties, structural properties or electrochemical properties. The different aspects may be one or more selected from the list consisting of electrical properties, chemical properties, physical properties, structural properties and electrochemical properties.

For example, two batteries may be different because they have different electrical properties, such as a different voltage profile. Two batteries may be different because they have different chemical properties, such as a different anode active material. Two batteries may be different because they have different structural properties, such as a different anode structure. Two batteries may be different because they have different physical properties, such as the degree of degradation from previous cell cycling.

Preferably, two of the batteries have two or more different aspects, such as three or more different aspects, or four or more different aspects. In this case, the different aspects may be two or more, preferably three or more, more preferably four or more, selected from the list consisting of electrical properties, chemical properties, physical properties, structural properties and electrochemical properties.

For example, two batteries may be different because they have different electrical properties, such as a different voltage profile, and different chemical properties, such as a different anode active material. Alternatively, two batteries may be different because they have different chemical properties, such as a different anode active material, and different structural properties, such as a different anode structure. Two batteries may be different because they have different structural properties, such as a different anode structure, and different physical properties, such as the degree of degradation from previous cell cycling.

Different electrical properties include different cell cycling properties. In some cases, the discharge and/or charge voltammogram are different, the nominal discharge and/or charge voltage (e.g. nominal voltage) are different, the cell voltage at 100% state of charge (SOC) is different, and/or the voltage profiles during discharging and/or charging are different. Preferably the nominal voltage is different, the cell voltage at 100% SOC is different and/or the voltage profiles during discharging and/or charging are different. More preferably the cell voltage at 100% SOC is different and/or the voltage profiles during discharging and/or charging are different. Most preferably the voltage profiles during discharging and/or charging are different.

The nominal voltage typically refers to the voltage at a certain SOC, such as the voltage at x % SOC, where x is from 0 to 100. The batteries are compared when x is the same for both batteries. The batteries are generally compared when the rate of discharge is the same for both batteries. Preferably, two batteries are different when the voltage is different at x % SOC when the battery is discharged at yC. For the batteries being compared, the value of x may be from 0 to 100, such as 20, 40, 60, 80 or 100. For the batteries being compared, the value of y may be 0.1 C to 5 C, such as 0.1 C, 0.2 C, 0.5 C, 1 C, 2 C, 3 C, 4 C or 5 C. Preferably the value of y is from 0.1 C to 0.2 C.

The voltage may be determined using any suitable method, such as measurement with a voltmeter. The SOC and/or rate of discharge/charge may be determined by any suitable means, such as column counting.

The cell voltage at 100% SOC may be different, or from 60 to 80% SOC may be different. Preferably, the cell voltage at from 50 to 90% SOC is different, such as from 0 to 100% SOC. The cell voltage is different when the two cells are at the same SOC (e.g. 50%, 60%, 70%, 80%, 90% or 100%) and the cell voltage is not the same. The cell voltage may differ by 0.01V or more, preferably 0.05V or more, even more preferably 0.1V or more, yet more preferably 0.2V or more. Cell voltage typically refers to the voltage of a single cell.

The voltage profile may refer to a plot of cell voltage verses SOC. A voltage profile during discharging may refer to a plot of cell voltage from 100% SOC to 0% SOC. A voltage profile during charging may refer to a plot of cell voltage from 0% SOC to 100% SOC. When the voltage profiles are different, this means that the profiles have an overlap coefficient of less than 1, preferably less than 0.9, less than 0.8, less than 0.7, less than 0.6 or less than 0.5. Most preferably the voltage profiles do not overlap (except at a point value).

Different chemical properties include different cell chemistries. Two or the batteries may be different if they have different cell chemistries. Different cell chemistry typically refers to at least one different electrode material, such as a different anode and/or different cathode material, or a different charge carrier. Preferably, different battery chemistry refers to different working electrode active material, such as cathode active material or anode active material. Preferably the anode active material is different. Different chemistry leads to the batteries being able to provide for different current draws, which in turn means that they require different power converters to provide a steady output.

Different structural properties include different cell morphology or structure. Two of the batteries may be different if they have different cell morphology. Different cell morphology may refer to the internal morphology of the electrode, such as particle size of electrode material, particle size distribution of electrode material, coating thickness (of films or particles), hierarchical or non-hierarchical structures in the electrode, porosity of the electrode, specific surface area of the electrode.

Different physical properties may also include different cell cycling conditions. Two or the batteries may be different if they have different cell cycling conditions. Different cell cycling conditions may include temperature, pressure or humidity, preferably temperature.

Different physical properties include different cell degradation levels. Two of the batteries may be different if they are degraded to different levels, for example due to the previous number of cell cycles or due to the method of manufacture. If the batteries are degraded to different levels due to the previous number of cell cycles, the different batteries may be termed a “first-life” battery and a “second-life” battery. In some embodiments, the first-life battery has been cycled less times than the second-life battery, and/or the first-life battery has been cycled at lower rates than the second-life battery. As a result, the voltage and/or specific capacity of the first-life battery at 100% SOC is typically higher than the second-life battery. The voltage profile of the first-life battery may also be different to the second-life battery.

For example, the first-life battery and second-life battery may have originally had the same chemistry but one of the batteries has been cycled over 5,000 times at a high rate and therefore is degraded and has lost capacity while the other is new and has not yet been cycled. Under these circumstances the batteries will have a different voltage at 100% SOC and therefore different voltage profiles on discharge and output at different current draws.

The battery is in electrical communication with the power converter and power connector, as described herein. The battery is also in communication with the controller. Data on the condition of the battery is sent to the controller, as described herein.

The Batteries Are Preferably Secondary Batteries, Also Known As Rechargeable Batteries.

The two or more batteries may be three or more batteries. Preferably the two or more batteries is three batteries.

Two or more of the batteries may be different when one battery is a high-rate battery and one battery is a low-rate battery.

One or more of the batteries may be a high-rate battery. The high-rate battery typically is a battery capable of a charge and/or discharge rate of 1 C or more, preferably 3 C or more, more preferably 5 C or more, yet more preferably 10 C or more, even more preferably 20 C or more. The high-rate battery may also be a low-capacity battery. The low-capacity battery is typically a battery having a total capacity (e.g. full charge capacity) of 1 kAh or less, 0.5 kAh or less, 0.2 kAh or less, 0.1 kAh or less, 0.05 kAh or less. A low-capacity battery typically is a battery having an energy storage capacity of 3 kWh or less, 2 kWh or less, 1 kWh or less, 0.5 kWh or less, 0.2 kWh or less, 0.1 kWh or less, 0.05 kWh or less.

The high-rate battery may have a discharge capacity retention of at least 70%, 75%, 80%, 85%, 90%, 95%, 96%, 97%, 98%, 99%, or 100% at 10 C charge and discharge rate maintained over at least 50, 100, 150, 200, 250, 300, 400, 500, 600, 700, 800, 900, 1,000, 1,200, 1,500, 1,800, or 2,000 cycles. Preferably, the high-rate battery has a capacity retention of at least 90% at 10 C charge and discharge rate maintained over at least 1,000 cycles.

The high-rate battery may have a discharge capacity retention of at least 70%, 75%, 80%, 85%, 90%, 95%, 96%, 97%, 98%, 99%, or 100% at 20 C charge and discharge rate maintained over at least 50, 100, 150, 200, 250, 300, 400, 500, 600, 700, 800, 900, 1,000, 1,200, 1,500, 1,800, or 2,000 cycles. Preferably, the high-rate battery has a capacity retention of at least 85% at 20 C charge and discharge rate maintained over at least 1,000 cycles.

The high-rate battery is preferably a niobium-containing metal oxide based battery, as described below.

One or more of the batteries may be a high-capacity battery. The high-capacity battery is typically a battery having a total capacity (e.g. full charge capacity) of 0.05 kAh or more, such as 0.1 kAh or more, 0.4 kAh or more, 0.8 kAh or more, 1 kAh or more. A high-capacity battery typically is a battery having an energy storage capacity of 0.05 kWh or more, such as 0.1 kWh or more, 0.4 kWh or more, 0.8 kWh or more, 1 kWh or more, 2 kWh or more, or 3 kWh or more.

The high-capacity battery may also be a low-rate battery. The low-rate battery typically is a battery only capable of a charge and/or discharge rate of 5 C or less, such as 4 C or less, 3 C or less, 2 C or less, 1 C or less, or 0.5 C or less.

The low-rate battery may have a discharge capacity retention of less than 100%, 95%, 90%, 85%, 80%, 75%, 70% at 5 C charge and discharge rates maintained over at least 50, 100, 150, 200, 250, 300, 400, 500, 600, 700, 800, 900, 1,000, 1,200, 1,500, 1,800, or 2,000 cycles. Preferably, the high-rate battery has a capacity retention of less than 90% at 5 C charge and discharge rate maintained over at least 1,000 cycles.

The low-rate battery may have a discharge capacity retention of less than 100%, 95%, 90%, 85%, 80%, 75%, 70% at 2 C charge and discharge rates maintained over at least 50, 100, 150, 200, 250, 300, 400, 500, 600, 700, 800, 900, 1,000, 1,200, 1,500, 1,800, or 2,000 cycles. Preferably, the high-rate battery has a capacity retention of less than 90% at 2 C charge and discharge rate maintained over at least 1,000 cycles.

The high-capacity (and optionally low-rate) battery may be a lead-acid battery, a nickel-cadmium battery, a nickel-metal hydride battery or a lithium battery. Preferably the high-capacity (and optionally low-rate) battery is a lead-acid battery.

Preferably the high-capacity low-rate battery is a lithium-ion battery. Suitable lithium-ion batteries include lithium-ion graphite, lithium iron phosphate (LiFePO₄), and lithium-ion polymer (Li-ion polymer) batteries. The high-capacity (and optionally low-rate) battery is preferably a lithium-ion battery having a graphite electrode or a lead acid battery, more preferably a lead acid battery.

The batteries may include one or more flow batteries, such as a redox flow battery. The redox flow battery may be a vanadium redox flow battery, polysulfide bromide battery, iron redox flow battery, or organic redox flow battery. The redox flow battery may be a full-flow battery or a hybrid (also known as semi-flow) redox flow battery.

Preferably, the two or more batteries comprise one or more low-capacity high-rate batteries and one or more high-capacity low-rate batteries. More preferably, the two or more batteries comprises one or more low-capacity high-rate batteries, one or more high-capacity low-rate batteries and a redox flow battery.

Preferably, the maximum operable discharge rate of the high-rate battery is higher than the maximum operable discharge rate of the high-capacity battery. The maximum operable discharge rate of the battery is the maximum rate of discharge where the capacity retention is at least 70%, 75%, 80%, 85%, 90%, 95%, 96%, 97%, 98%, 99%, or 100% maintained over at least 50, 100, 150, 200, 250, 300, 400, 500, 600, 700, 800, 900, 1,000, 1,200, 1,500, 1,800, or 2,000 cycles. Preferably the maximum operable discharge rate of the high-rate battery is 3 C or more, preferably 5 C or more, more preferably 10 C or more, even more preferably 20 C or more.

Preferably, the maximum operable charge rate of the high-rate battery is higher than the maximum operable charge rate of the high-capacity battery. The maximum operable charge rate of the battery is the maximum rate of charge where the capacity retention is at least 70%, 75%, 80%, 85%, 90%, 95%, 96%, 97%, 98%, 99%, or 100% maintained over at least 50, 100, 150, 200, 250, 300, 400, 500, 600, 700, 800, 900, 1,000, 1,200, 1,500, 1,800, or 2,000 cycles. Preferably the maximum operable charge rate of the high-rate battery is 3 C or more, preferably 5 C or more, more preferably 10 C or more, even more preferably 20 C or more.

In some embodiments, the maximum operable discharge rate of the high-rate battery is 3 C or more, where the capacity retention is at least 70% over 1,000 cycles, preferably 5 C or more, where the capacity retention is at least 70% over 1,000 cycles, more preferably 10 C or more where the capacity retention is at least 70% over 1,000 cycles.

In some embodiments, the maximum operable discharge rate of the high-rate battery is 3 C or more, where the capacity retention is at least 80% over 1,000 cycles, preferably 5 C or more, where the capacity retention is at least 80% over 1,000 cycles, more preferably 10 C or more where the capacity retention is at least 80% over 1,000 cycles.

In some embodiments, the maximum operable discharge rate of the high-rate battery is 3 C or more, where the capacity retention is at least 90% over 1,000 cycles, preferably 5 C or more, where the capacity retention is at least 90% over 1,000 cycles, more preferably 10 C or more where the capacity retention is at least 90% over 1,000 cycles.

Preferably, the maximum discharge capacity of the high-rate battery is lower than the maximum discharge capacity rate of the high-capacity battery. The maximum discharge capacity is the charge released from the battery when it is discharged from a fully charged state to a fully discharged state. The battery may be regarded as fully charged when the voltage passes a threshold value. For example, an electrochemical cell comprising a lithium metal anode and a niobium tungsten oxide cathode may be regarded as fully charged when the voltage rises above a practicable level, such as where the voltage rises above 2.0 V against Li/Li⁺, such as above 2.25 V or above 2.5 V. The battery may be regarded as fully discharged when the voltage passes a threshold value. For example, an electrochemical cell comprising a lithium metal anode and a niobium tungsten oxide cathode may be regarded as fully discharged when the voltage drops below a practicable level, such as where the voltage drops below 1.5 V against Li/Li⁺, such as below 1.25 V or below 1.0 V. Preferably, the maximum discharge capacity of the high-capacity battery is 100 Ah or more, such as 500 Ah or more, 1 kAh or more, 2 kAh or more, 5 kAh or more.

The high-rate (optionally low capacity) battery allows the system to operate at high rates for a short period of time. For example, to facilitate a surge in power demand or to facilitate rapid charging from a source. The high-capacity low-rate battery allows the system to operate at lower rates for a long period of time, to provide consistent long term power supply and to facilitate slow charging from a low-rate charger, for example. In this way, the system can adapt to a range of discharging and charging conditions.

Preferably, one or more batteries of the system is a battery comprising an electrochemical cell. The electrochemical cell typically has a working electrode active material comprising a metal oxide, preferably a niobium-containing metal oxide. Alternatively, the electrochemical cell may have a working electrode active material comprising particles of graphite, silicon, SiOₓ (where x is from 0 to 2), or LTO.

The electrochemical cell comprises a working electrode. The working electrode may be an anode or cathode during a discharge step, for example in a lithium-ion battery. Typically, the working electrode is the anode during discharge (e.g. galvanic discharge).

The electrochemical cell typically further comprises a counter electrode and an electrolyte. The electrochemical cell may comprise a current collecting plate.

The electrochemical cell may be a lithium-ion cell.

The counter electrode may be an anode or cathode during a discharge step, for example in a lithium-ion battery. The counter electrode is typically the cathode during discharge (e.g. galvanic discharge).

Where there is a plurality of cells, these may be provided in series or parallel, or a mixture of cells in series and in parallel.

The battery may comprise any number of cells and may be made up of one or more sub-batteries. The battery may be a modular system such that sub-batteries are replaceable.

The electrochemical cell may also refer to a battery comprising a plurality of electrochemical cells. The electrochemical cells may be connected in series or in parallel.

The battery may include a battery management system (BMS). The BMS may be integral with the battery. The BMS may communicates with the controller and/or the power converter. Preferably, the BMS communicates with the controller. The BMS may include a temperature sensor, voltage sensor and/or a current sensor. Information on the temperature, voltage and/or current may be sent to the controller and/or the power converter.

### Working Electrode

The working electrode may be an anode or cathode during a discharge step, for example in a lithium-ion battery. Preferably, the working electrode is the anode during a discharge step (e.g., galvanic discharge). The working electrode is electrically conductive, and is electrically connectable to a counter electrode, for example within an electrochemical cell.

In some embodiments, the working electrode comprises a niobium-containing metal oxide. A niobium-containing metal may be selected from Nb₂O₅ polymorphs, NbO₂, Nb₂O₃ or combinations thereof.

The niobium-containing metal oxide may be a mixture (for example, an amorphous mixture) of a niobium oxide and an additional metal oxide. Suitable additional metal oxides include titanium oxide, hafnium oxide, tantalum oxide or aluminium oxide.

The niobium-containing metal oxide may be a compound (for example, having a crystalline structure) of a niobium oxide and an additional metal oxide. Suitable niobium-containing metal oxides include niobium tungsten oxide (for example Nb₁₆W₅O₅₅ or Nb₁₈W₁₆O₉₃), a titanium niobium oxide (for example TiNb₂O₇), a niobium molybdenum oxide (for example Nb₂Mo₃O₁₄), or combinations thereof.

Suitable niobium tungsten oxides include Nb₁₂WO₃₃, Nb₂₆W₄O₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, or Nb₂W₁₅O₅₀ or combinations thereof.

In some embodiments, the working electrode comprises a niobium-containing metal oxide material having a molar ratio of Nb₂O₅ to WO₃ from 6:1 to 1:15. Preferably, the molar ratio of Nb₂O₅ to WO₃ in the working electrode is from 8:5 to 11:20. More preferably, the molar ratio of Nb₂O₅ to WO₃ in the working electrode is 8:5 or 9:16.

In some embodiments the working electrode active material comprises Nb₁₆W₅O₅₅, Nb₁₈W₈O₆₉, Nb₂WO₈, Nb₁₈W₁₆O₉₃, or Nb₂₂W₂₀O₁₁₅, or combinations thereof. Preferably the working electrode comprises Nb₁₆W₅O₅₅ or Nb₁₈W₁₆O₉₃, or combinations thereof.

In some embodiments, the working electrode comprises graphite, Si, SiOₓ (where x is typically from 0 to 2), LTO, or a mixture thereof. In some embodiments, the working electrode consists essentially of graphite Si, SiOₓ (where x is typically from 0 to 2), or lithium titanate (LTO). Preferably, the working electrode comprises these compounds (e.g. graphite) in particulate form. The size of the particles of the working electrode may be known, or it may be determined using standard techniques such as SEM. The particles of the working electrode may have a primary particle size of at least 1 μm. The primary particle size is the size of the individual crystallite. It is the smallest identifiable subdivision in a particulate system. For example, the particles may have a primary particle size of at least 2 μm, 3 μm, 4 μm, 5 μm or 10 μm. Preferably the primary particle size is less than 100 μm, 50 μm, 30 μm, 20 μm or 10 μm. The particular particle size may result in higher lithium diffusion coefficients, which allow for high discharge rates of the electrochemical cell.

The graphite particles may agglomerate to form secondary particles. Typically, the graphite particles have an agglomerate (secondary) particle size of at least 5 μm. More preferably, the agglomerate graphite particles have an agglomerate particle size of at least 10 μm, 15 μm, 20 μm, 25 μm or 30 μm.

Optionally, the working electrode comprises a mixture of niobium tungsten oxide and an additional active material. The additional active material may be an additional metal oxide. For example, the working electrode may comprise a mixture of niobium tungsten oxide and an additional active material selected from lithium titanate (LTO; Li₄Ti₅O₁₂), titanium niobium oxides (for example TiNb₂O₇), titanium tantalum oxides (for example TiTa₂O₇), tantalum molybdenum oxides (for example Ta₈W₉O₄₇) and niobium molybdenum oxides (for example Nb₂Mo₃O₁₄).

Graphite may also be used as an additional active material. A working electrode comprising a mixture of niobium tungsten oxide and graphite is cheaper to produce while maintaining the beneficial properties outlined above.

Preferably, the working electrode comprises a mixture of niobium tungsten oxide and LTO. The ratio of niobium tungsten oxide to LTO may be from 95:5 to 5:95 by weight. For example, the ratio may be from 90:10 to 10:90 by weight, from 80:20 to 20:80 by weight, from 70:30 to 30:70 by weight, from 60:40 to 40:60 by weight or the ratio of niobium tungsten oxide to LTO may be 1:1 by weight.

Preferably, the working electrode consists essentially of niobium tungsten oxide and an additional active material. For example, the working electrode consists essentially of a mixture of niobium tungsten oxide and LTO.

Typically, the working electrode does not have a porous nor hierarchical structure. For example, the electrode material may have a specific surface area of less than 20 m²·g⁻¹, less than 10 m²·g⁻¹, less than 5 m²·g⁻¹, less than 3 m²·g⁻¹, less than 2 m²·g⁻¹ or less than 1 m²·g⁻¹. The specific surface area of the electrode material may be known, or it may be determined using standard techniques such as N₂ adsorption isotherm analysis and Brunauer-Emmett-Teller (BET) theory.

Alternatively, the working electrode may have a porous structure. For example, the working electrode may have a specific surface area of at least 50 m²·g⁻¹, at least 60 m²·g⁻¹, 70 m²·g⁻¹, 80 m²·g⁻¹, 90 m²·g⁻¹, 100 m²·g⁻¹, 150 m²·g⁻¹, 200 m²·g⁻¹, 300 m²·g⁻¹, or 400 m²·g⁻¹.

The working electrode may have a pore volume of of at least 0.1 cm³·g⁻¹, at least 0.2 cm³·g⁻¹ at least 0.4 cm³·g⁻¹, at least 0.5 cm³·g⁻¹, at least 0.7 cm³·g⁻¹, at least 0.8 cm³·g⁻¹, at least 0.9 cm³·g⁻¹, at least 1.0 cm³·g⁻¹, at least 1.5 cm³·g⁻¹ or at least 2.0 cm³·g⁻¹. The pore volume of the electrode material may be known, or it may be determined using standard techniques such as N₂ adsorption isotherm analysis and Barrett-Joyner-Halenda (BJH) theory.

The porous working electrode may have an average pore size (largest cross section) of at least 1 nm, at least 5 nm, at least, 10 nm, at least 20 nm, at least 30 nm, at least 40 nm, at least 50 nm or at least 100 nm.

The porous working electrode may have a macroporous structure. Thus, the porous working electrode may contain pores having a largest cross section of at least 200 nm, at least 500 nm, at least 1 μm, or at least 5 μm.

The pore size of the electrode material may be known, or it may be determined using standard techniques such as scanning electron microscopy (SEM). The working electrode may additionally comprise porous carbon, such as porous reduced graphene oxide.

Electrodes comprising porous carbon are generally light and conductive, and can provide large pore volumes, which can allow rapid transport of lithium ions and electrons to the active materials. They may also increase the electrochemical capacity of the working device.

The working electrode may additionally comprise reduced graphene oxide, Ketjen black or Super P carbon. Alternatively, the working electrode may have a hierarchical structure. For example, the working electrode may additionally comprise hierarchical reduced graphene oxide (rGO).

Preferably, the working electrode comprises a niobium tungsten oxide in particulate form. The size of the niobium tungsten oxide particles of the working electrode may be known, or it may be determined using standard techniques such as SEM. The niobium tungsten oxide particles of the working electrode may have a primary particle size of at least 1 μm. The primary particle size is the size of the individual crystallite. It is the smallest identifiable subdivision in a particulate system. For example, the niobium tungsten oxide particles have a primary particle size of at least 1 μm, 2 μm, 3 μm, 4 μm, 5 μm or 10 μm, such as from 1 to 100 μm, preferably from 2 to 50 μm, more preferably from 3 to 10 μm.

The individual niobium tungsten oxide particles may agglomerate to form secondary particles. Typically, the niobium tungsten oxide particles have an agglomerate (secondary) particle size of at least 5 μm. More preferably, the niobium tungsten oxides have an agglomerate particle size of at least 1 μm, 2 μm, 3 μm, 5 μm or 10 μm, such as from 1 to 100 μm, preferably from 2 to 20 μm, more preferably from 3 to 10 μm.

Where present, the additional active material may be in particulate form. The size of the additional active material particles may be known, or it may be determined using standard techniques such as SEM.

Preferably, the additional active material particles have a primary particle size of 1 μm or less. For example, the additional active material particles have a primary particle size of 800 nm or less, 750 nm or less, 700 nm or less, 600 nm or less, 500 nm or less, 400 nm or less, 300 nm or less, 200 nm or less or 150 nm or less. Particulate lithium titanate typically has a particle size within this range.

Electrodes comprising a mixture of niobium tungsten oxide and an additional active material having particle sizes within the ranges described above can be charged and discharged at very high C-rates and at very high charge densities.

To improve conductivity at the working electrode, a conductive carbon material (e.g., carbon black, graphite, nanoparticulate carbon powder, carbon fiber and/or carbon nanotubes) is typically admixed with the working electrode material. Alternatively, the conductive carbon material may be coated onto the working electrode material. In one embodiment, the working electrode comprises porous carbon, such as porous reduced graphene oxide, which may wrap the larger niobium oxides particles.

Typically, the working electrode contains from 1 to 10% by weight of binders, preferably from 5 to 10% by weight of binders.

The electrode may consist essentially of niobium tungsten oxide.

Alternatively, the working electrode is admixed with a binder or adhesive. Some examples of binders or adhesives include PVDF, PTFE, CMC, PAA, PMMA, PEO, SBR and co-polymers thereof.

The working electrode is typically fixed to a current collector, such as a copper or aluminum collector, which may be in the form of a plate.

In some embodiments the working electrode comprising a particulate niobium tungsten oxide using a standard electrode configuration of 8:1:1 active material/carbon/binder with a 2-3 mg·cm² loading of active material and a 1.27 cm² electrode area against a lithium counter electrode and using 1.0 M LiPF₆ in ethylene carbonate/dimethyl carbonate as electrolyte. Under these conditions, the cell may maintain a capacity of up to 150 mA·h·g⁻¹ at 10 C for 1000 cycles, and a capacity of up to 125 mA·h·g⁻¹ at 20 C for 750 cycles.

Under these conditions the niobium tungsten oxides have a solid-state lithium diffusion coefficient (DLi) of 10⁻¹³ to 10⁻¹² m²·s⁻¹ at 298 K. This corresponds to a characteristic diffusion length of ca. 10 μm for a 1-minute discharge.

In some embodiments the working electrode comprises a niobium molybdenum oxide. The working electrode is electrically conductive, and is electrically connectable to a counter electrode, for example within an electrochemical cell. Typically, the working electrode comprises a molar ratio of Nb₂O₅ to MoO₃ of from 6:1 to 1:3. Preferably, the molar ratio of Nb₂O₅ to MoO₃ in the working electrode is 1:3. Preferably, the working electrode comprises a niobium molybdenum oxide selected from Nb₂Mo₃O₁₄, Nb₁₄Mo₃O₄₄ or Nb₁₂MoO₄₄. More preferably, the working electrode comprises Nb₂Mo₃O₁₄.

The working electrode may not have a porous nor hierarchical structure. The working electrode may have a specific surface area, pore volume and average pore size as described above. Typically, the working electrode comprises a niobium molybdenum oxide in particulate form. The niobium molybdenum oxide particles of the working electrode may have a primary or agglomerate particle size as described above.

### Counter Electrode

The electrochemical cell typically comprises a counter electrode. The counter electrode may be an anode or cathode during a discharge step, for example in a lithium-ion battery. Preferably the counter electrode is the cathode during a discharge step.

A plurality of battery cells refers to one or more electrochemical cells, as described herein.

In addition to the working electrode, an electrochemical cell comprises a counter electrode and an electrolyte, and optionally a separator, such as a microporous polyethylene film, between the working electrode and counter electrode.

Suitable materials for the counter electrode include lithium-containing or lithium-intercalated material, such as a lithium metal oxide, wherein the metal may be a transition metal such as Co, Fe, Ni, V, or Mn, or combination thereof. Some examples of counter electrode materials include lithium cobalt oxide (LiCoO₂) lithium nickel manganese cobalt oxide (NMC, LiNiMnCoO₂, e.g., LiNi_{0.6} CO_{0.2}Mn_{0.2}O₂), lithium vanadium fluorophosphate (LiVPO₄F), lithium nickel cobalt aluminium oxide (NCA, LiNiCoAl₂), lithium iron phosphate (LFP, LiFePO₄) and manganese-based spinels (e.g. LiMn₂O₄). In one embodiment, the counter electrode is substantially free of binders. In an alternative embodiment, the counter electrode is admixed with a binder or adhesive. Some examples of binders or adhesives include PVDF, PTFE, CMC, PAA, PMMA, PEO, SBR and co-polymers thereof. The counter electrode may be fixed to a current collecting substrate, such as an aluminium plate.

### Electrolyte

The electrolyte comprises lithium salts, such as lithium (bis(trifluoromethane)sulfonimide (LiTFSI), LiPF₆, LiBF₄, LiClO₄, lithium triflate (LiTF), or lithium bis(oxalate)borate (LiBOB). The electrolyte may be a liquid electrolyte, such as a liquid at ambient temperature, for example at 25° C. The electrolyte may be a non-aqueous electrolyte. The electrolyte may comprise a polar aprotic solvent, such a cyclic or linear carbonate, such as ethylene carbonate, dimethyl carbonate, or ethyl methyl carbonate.

Suitable solvents include carbonate solvents. For example propylene carbonate (PC), ethylene carbonate (EC), butylene carbonate (BC), chloroethylene carbonate, fluorocarbonate solvents (e.g., fluoroethylene carbonate and trifluoromethyl propylene carbonate), as well as the dialkylcarbonate solvents, such as dimethyl carbonate (DMC), diethyl carbonate (DEC), dipropyl carbonate (DPC), ethyl methyl carbonate (EMC), methyl propyl carbonate (MPC), and ethyl propyl carbonate (EPC).

Suitable solvents also include sulfone solvents. For example methyl sulfone, ethyl methyl sulfone, methyl phenyl sulfone, methyl isopropyl sulfone (MiPS), propyl sulfone, butyl sulfone, tetramethylene sulfone (sulfolane), phenyl vinyl sulfone, allyl methyl sulfone, methyl vinyl sulfone, divinyl sulfone (vinyl sulfone), di phenyl sulfone (phenyl sulfone), dibenzyl sulfone (benzyl sulfone), vinylene sulfone, butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl)toluene, 2-(methylsulfonyl) ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl)sulfone and 2-methoxyethoxyethyl(ethyl)sulfone).

Suitable solvents also include silicon-containing solvents such as a siloxane or silane. For example, hexamethyldisiloxane (HMDS), 1,3-divinyltetramethyldisiloxane, the polysiloxanes, and polysiloxane-polyoxyalkylene derivatives. Some examples of silane solvents include methoxytrimethy Isilane, ethoxytrimethy Isilane, dimethoxydimethylsilane, methyltrimethoxysilane, and 2-(ethoxy)ethoxytrimethylsilane.

Typically, an additive may be included in the electrolyte to improve performance. For example vinylene carbonate (VC), vinyl ethylene carbonate, allyl ethyl carbonate, t-butylene carbonate, vinyl acetate, divinyl adipate, acrylic acid nitrile, 2-vinyl pyridine, maleic anhydride, methyl cinnamate, ethylene carbonate, halogenated ethylene carbonate, a-bromo-y-butyrolactone, methyl chloroformate, 1,3-propanesultone, ethylene sulfite(ES), propylene sulfite (PS), vinyl ethylene sulfite (VES), fluoroethylene sulfite (FES), 12-crown-4 ether, carbon dioxide (CO₂), sulfur dioxide (SO₂), and sulfur trioxide (SO₃).

The electrochemical cell may also include a separator, such as a solid porous membrane positioned between the working and counter electrodes. The solid porous membrane may partially or completely replace the liquid electrolyte. The solid porous membrane may comprise a polymer (e.g., polyethylene, polypropylene, or copolymer thereof) or an inorganic material, such as a transition metal oxide (e.g., titania, zirconia, yttria, hafnia, or niobia) or main group metal oxide, such as silicon oxide, which can be in the form of glass fiber.

The solid non-porous membrane may comprise a lithium-ion conductor. For example, LLZO (garnet family), LSPO(LISICON family), LGPS (thio-LISICON family), LATP/LAGP (NASICON family), LLTO(perovskite family) and phosphide/sulfide glass ceramics.

### Power Connector

The system includes a power connector. The power connector is separably connectable with a load or a source. Any suitable power connectors may be used, provided they allow electrical communication between the charging device an an external source or load (e.g. an electrical device or a power supply).

Suitable power connectors include plug and socket connections. Examples of suitable power connectors include domestic plug and socket connections, such as BS 1363 three-pin (rectangular) standard, BS 546 three-pin (round), CEE 7 two-pin standard, China GB 2099.1-2008 and GB 1002-2008 standards, IEC 60906-2 two-pin US standards, RAM 2073 and 2071 (Type I), S/NZS 3112 (Type I).

The power connector is for connecting to a load in order to discharge the system's battery to the load. When the power connector is for connecting to a load it may be referred to as a power output. The power output is typically for discharging the battery.

The power output may be any suitable means of delivering power from the system to the load, by discharging the batteries of the system. The power output is connectable to the load by any suitable connection, such as by a conventional charging cable or inductive charging.

The power connector may also be for connecting to a power source, such as a power supply, for charging the system's batteries. When the power connector is for connecting to a power source it may be referred to as the power input. The power input is typically for charging the system's batteries.

The power input may be any suitable means of supplying power to the system, to charge the batteries of the system. Typically, the power input is connectable to mains electricity, such as a domestic or commercial power supply, a car charger (e.g. a “wall box”) or a EV charging station.

Any suitable power input or power output can be used, such AC power or DC power. The input power may be 3-phase AC power (e.g. from a domestic power supply) or may be a DC direct connection (e.g. from a EV charging station). Preferably the power output is DC power.

In some embodiments the power connector includes a separate power input and power output connector. Preferably, the power output is a DC connector. Preferably the power input may be an AC or DC connector, more preferably the power input is a DC connector. The power input or output may be a switchable AC and DC connector.

In some embodiments the power connector includes a unitary power input and power output. In this embodiment, a single power connector is used for charging and discharging the system's batteries. Preferably, the unitary power input and power output is a switchable AC and DC connector. The power connector may be bidirectional.

In some embodiments the power connector comprises a sensor, for detecting if a power supply and/or a load is connected to the power connector. Any suitable sensor may be used, such as an optical sensor or a voltmeter/ohmmeter across the power connector(s). Typically, the sensor is in communication with the controller, for signaling to the controller when something is connected to the power connector.

In some embodiments the power connector comprises a data connector, for communication between the system and the load and/or the system and the power source. Any suitable data connector may be used, which can transfer data to and/or from the system's controller to the load or power source. Preferably the data connector is integral with the power connector.

### Power Converter

The system includes a power converter.

The power converter is in electrical communication with the two or more batteries and the power connector. The power converter is in communication with the controller. Typically, the power converter controls the rate of discharge and/or charge of the batteries to/from the power connector. The power converter controls the rate of discharge from the batteries to the power connector when the power connector is connected to a load. The power converter controls the rate of charge from the power connector to the batteries when the power connector is connected to a source. The rate of charge and/or discharge is adjusted based on signals from the controller.

The power converter may send data to the controller, such as data on the condition of the battery or batteries electrically connected to the power converter.

The power converter may comprise a means of measuring data. Any suitable means of measuring the data may be used. For example, voltage may be measured using a voltmeter, current by an ammeter, resistance by an ohmmeter, temperature by a thermocouple, isolation resistance by a high input impedance ohmmeter, and state of charge, state of balancing and power availability by voltmeter (e.g. by comparing the voltage to a predetermined voltage profile) or by an ammeter (e.g. by “coulomb counting”).

The data may be processed in the power converter (e.g. in the measurement device of the power converter) and sent to the controller. Alternatively, unprocessed data may be sent to the controller from the power converter, and the data processed by the controller.

The power converter may receive data from the controller, such as data on the load or the source. This may include information on the voltage and/or current provided by the source or demanded by the load. The controller operates to control the output voltage and or output current according to the system demands by sending data on the discharge required to the power converter. The controller operates to control the input voltage and or input current according to the source power by sending data on the source power to the power converter.

The power converter may send and receive data to and from the controller by any suitable means, such as by electronic signals.

The power converter is typically used to convert power for the power output (e.g. when the two or more batteries are discharged to a load) and the power input (e.g. when the two or more batteries are charged from a source). In some embodiments separate power converters are used for the power input and the power output. In other embodiments the same power converter is used for both the power input and the power output, and preferably the power converter is bidirectional.

Preferably a separate power converter is used for each of the two or more batteries. Preferably each power converter is in series with each of the two or more batteries.

A power converter may be used to convert power for transfer between the two or more batteries (e.g. when the two or more batteries are being balanced). In some embodiments an additional power converter may be used converting power for transfer between the two or more batteries. In other embodiments the same power converter is used as for the power input and the power output. Preferably the power converter is bidirectional (e.g., to allow power to transfer between the two or more batteries in either direction).

The power inverter may include a gate driver. Suitable gate drivers typically include a level shifter and an amplifier.

The power converter may include a power conditioning system. Suitable power conditioning systems are known in the art. The power condition system may include a surge protector, frequency corrector or voltage corrector. The power conditioning typically smooths or decreases variability in the power.

The power converter may include an inverter (i.e. which changes direct current (DC) to alternating current (AC)) or converter (i.e. AC to DC, or DC to DC). Suitable inverters or converters are known in the art. Typically, a DC-DC converter is comprised in the charging engine. Suitable DC-DC converters are known in the art, such as buck, boost, or a buck-boost converter. The buck converter is operable to step down or decrease the voltage. The boost converter is operable to step up or increase the voltage. Suitable AC-AC converters are known in the art, such as transformers.

DC power (e.g. from the two or more batteries or from a power source) may be passed through a power conditioner. This power conditioner may carry out appropriate power conditioning, converting the voltage received from the power connector as appropriate and accordingly may incorporate or be connected to a boost, buck, or buck-boost DC-DC converter in order to carry out power conditioning.

Preferably, the power converter comprises a buck, boost or a buck-boost converter, more preferably a buck-boost converter. The buck-boost converter may comprise separate buck and boost circuits combined by a switching system. Preferably, the buck-boost converter is a combined buck-boost circuit.

AC power (e.g. from a domestic power source) may be passed through an AC/DC charging engine to charge the two or more batteries. The AC/DC charging engine carries out any required conversion and power conditioning.

In some embodiments the power converter can be bypassed, so the power connector is connected directly to the battery. Certain parts of the power converter may be bypassed, such as the gate drive, power conditioner, converter or inverter. The bypass may be controllable, so that the controller can control which parts of the power converter are used and which are bypassed. For example, when the input is a DC input the controller may bypass a converter in the power converter, or when the output is DC, the controller may bypass an inverter in the power converter.

The power converter may also adjust the discharge rate (or charge rate) of individual or groups of electrochemical cells comprised in the battery, thereby balancing the electrochemical cells in the battery. The power converter may also adjust the discharge rate (or charge rate) of individual batteries comprised in the two or more batteries, thereby optimising the discharging or charging of the two or more batteries.

The power converter may also send data about the state of charge (e.g. voltage) of individual or groups of electrochemical cells comprised in the battery. The power converter may also send data about the state of charge (e.g. voltage) of batteries comprised in the two or more batteries. This data may then be used by the controller to balance the cells or batteries, which reduces the amount of overvoltage or undervoltage of any individual cell.

The power converter may include a voltage proportional integral derivative (PID) controller and/or a current PID controller. The voltage PID and current PID allow the current and voltage to be controlled.

The power converter may include a pulse width modulation (PWM) signal generator. The PWM generator operates on DC-DC current and outputs a pulse signal in order to activate another component of the power converter. For example, the PWM generator may output a pulse in order to activate the buck or boost converter. The pulse may open a switch (e.g. a FET) of the buck or boost converter.

The power converter may include a switching device, such as a power stage. The power stage may include a switch and a gate driver. The gate driver controls a switch which may allow switching of the output or input from the power converter. The switching of the power converter may be determined by a duty cycle dictated by signalling from the controller. Thus, the switching device may determine the activation of the power converter during charging or discharging.

The power converter may include an output monitor. The output monitor measures the power output from the power converter to the load, such as the output voltage and output current. The output monitor reports the power output to the controller. The controller may compare the power output measured by the output monitor to the power demand.

The power converter may include an input monitor. The input monitor may be the same as the output monitor, where the output monitor is bidirectional. The input monitor measures the power input from the power source to the power converter, such as the input voltage and output current. The input monitor reports the power input to the controller. The controller may compare the power input measured by the input monitor to the power demand of the batteries.

### Controller

The system includes a controller. The controller is in communication with the two or more batteries and receives data from the two or more batteries. The data from the two or more batteries typically relates to the condition of the two or more batteries. The controller is in communication with the power converter and adjusts the rate of discharge or charge by communication with the power converter. The controller may also receive data about the condition of the power converter.

The controller signals to the power converter to control the discharge or charge rate of each of the two or more batteries in response to data from the two or more batteries, to provide a constant power from the two or more batteries to the single load or to provide a constant power from the source to the two or more batteries.

The controller receives data from the two or more batteries. Preferably the controller receives data from each of the two or more batteries. The data from the two or more batteries can be used to indicate the condition of the two or more batteries during discharging or charging.

The data from the two or more batteries can be used to indicate the condition of each battery during discharging or charging.

In addition, the controller may receive data on the two or more batteries. The data on the two or more batteries may be from the two or more batteries or from the battery management system of the two or more batteries. Preferably, the data is from the battery management system of the two or more batteries.

The controller may receive data from the power converter. The data from the power converter can be used to indicate the condition of the two or more batteries during discharging or charging. The data may also be used to indicate the condition of the power converter(s).

In some embodiments, the data is selected from the list comprising at least one of battery voltage, battery temperature, battery isolation resistance, discharge current, state of charge of the electrochemical cells, state of balancing of the electrochemical cells, and power availability of the battery.

In some embodiments the data comprises voltage and temperature. In some embodiments, the data comprises voltage, current, and temperature.

The data may be sent to the controller by any suitable means known in the art, such as by electronic communication.

The data may be processed before sending to the controller. The data may be processed by the BMS or power converter, and then sent to the controller. Alternatively, unprocessed data may be sent to the controller, and the data may be processed by the controller.

The data is preferably sent frequently enough to determine the condition of the two or more batteries. The data is preferably sent frequently enough to determine the demand of the load or the power provided from the source. The frequency refers to how often the data is sent from the battery and power controller to the controller. The frequency may also refer to the measurement frequency of the data at the battery and power converter. Data may be sent to the controller at a frequency of from 0.01 to 10 seconds, preferably from 0.1 to 1 seconds, more preferably from 0.2 to 0.5 seconds, such as about 0.25 seconds.

The controller responds to the data by adjusting the discharge rate (or the charge rate) of the two or more batteries. Typically, the controller compares the data on the condition of each battery against an acceptable range and determines if the discharge rate should be increased or decreased. Typically, the controller also compares the data on the demand from the load and/or the power supply from the source and determines which of the batteries should be discharged or charged to provide power to the load or receive power from the source. The controller signals to the power converter to increase or decrease the rate of discharge or charge for each of the two or more batteries.

The controller may start and stop charging and discharging of the charging device battery. The controller may receive a signal to start and/or stop charging and discharging.

The signal may be from the load or source, a user interface, or another input. The controller may detect when a connection is made to the power input or output, in order to start charging or discharging. The controller may detect when a connection is removed from the power input or output, in order to stop charging or discharging.

The controller may receive data sent from a load. The data may be the same as that sent to the controller from the battery of the system. The controller may receive data from the load and then signal to the power converter to output power, based on the data.

The controller may receive data sent from the source. The data may include if the source provides AC or DC power, the voltage of the power, the frequency (for AC power), the current of the power. The controller may then signal to the power converter how to treat the input power, based on the data from the source.

The controller may also receive data about the state of charge (e.g. voltage) of individual or groups of electrochemical cells comprised in the two or more batteries. This data may then be used by the controller to balance the cells in the two or more batteries. Improved balancing may reduce the amount of overvoltage or undervoltage of any individual cell, which in turn reduces potential damage to the cells. The controller typically balances the cells while the battery is discharging, which can improve the discharge rate of the battery as the stress on the battery is reduced due to the improved balancing of the cells. The controller may balance the electrochemical cells of the one or more of the batteries. The controller may discharge individual or groups of electrochemical cells of the battery, thereby balancing the electrochemical cells of the battery. The controller may increase the rate of discharge for cells having a higher state or charge (e.g. higher voltage) and/or decrease the rate of discharge for cells having a lower state of charge (e.g. lower voltage).

The controller may independently adjust the discharge or charge rate of two or more of the batteries. This may in turn balance the two or more batteries.

In addition, the system may balance the batteries by independently adjusting the discharge or charge rate of two or more of the batteries and/or by transferring power between the two or more batteries. Preferably, the controller is for balancing the batteries such that the two or more batteries have substantially the same state of charge.

The controller preferably balances the batteries during charging and discharging of the two or more batteries, by adjusting the discharge or charge rate of the two or more batteries independently. Adjusting the relative discharge or charge rate of the two or more batteries allows one battery to be discharged/charged quicker relative to another battery, to change the relative SOC of the two or more batteries. The relative discharge or charge rate of the two or more batteries is adjusted such that the batteries provide a constant power to the load or receive a constant power from the source. The relative discharge or charge rate of the two or more batteries is typically adjusted such that data on the condition of the two or more batteries is maintained within an acceptable range.

In addition or alternatively, the controller may balance the batteries by transferring power between the two or more batteries. This may occur while the batteries are charging and discharging (e.g., when the system is providing power to a load or receiving power from a source) or when the system is not providing or receiving power.

In some embodiments, when discharging the multiple batteries to a load the controller balances the batteries by independently adjusting the discharge rate of two or more of the batteries and/or by transferring power between the two or more batteries. Preferably during discharge of the multiple batteries to a load the controller balances the batteries by transferring power between the two or more batteries.

In some embodiments, when charging the multiple batteries from a source the controller balances the batteries by independently adjusting the charge rate of the two or more batteries and/or by transferring power between the two or more batteries. Preferably during charging of the multiple batteries from a source the controller balances the batteries by independently adjusting the charge rate of the two or more batteries.

In a preferred embodiment, when charging the multiple batteries from a source the controller balances the batteries by independently adjusting the charge rate of the two or more batteries and then when discharging the multiple batteries to a load the controller balances the batteries by transferring power between the two or more batteries.

Balancing of the two or more batteries typically refers to adjusting the state of charge of the two or more batteries such that they have substantially the same state of charge (SOC). Accordingly, balancing of the two or more batteries results in the two or more batteries having a more similar SOC than before balancing. The balancing of the two or more batteries may result in the two or more batteries having a SOC which differs by less than a certain amount, such as a SOC which differs by ±20% or less, preferably ±15% or less, more preferably ±10% or less, even more preferably ±5% or less.

Alternatively, balancing of the two or more batteries may refer to adjusting the state of charge of the two or more batteries such that they have an optimal state of charge. The optimal state of charge may depend on aspects of the battery, such as the electrical properties, chemical properties, physical properties, structural properties or electrochemical properties. The optimal state of charge may depend on the maximum operable charge and/or discharge rate of the battery, and/or the maximum capacity of the battery.

The optimal state of charge may be a predetermined optimal state of charge (SOC) range. For example, the one or more low-rate batteries may have an optimal SOC range which is 0 to 100%, while the one or more high-rate batteries may have an optimal SOC range which is 20 to 80%. The optimal SOC range may be adapted by the intended use of the system. For example, where the system is used in an electric vehicle the one or more low-rate batteries may have an optimal SOC range which is 50 to 100%, while the one or more high-rate batteries may have an optimal SOC range which is 20 to 50%. In this way, the low-rate battery has a high SOC to store the majority of the energy needed to power the vehicle, while the high-rate battery has a low SOC so it is ready to accept energy from a fast charger or regenerative braking system.

The optimal state of charge may be a predetermined difference in the SOC between the batteries. The balancing of the two or more batteries may result in the two or more batteries having a SOC where one or more of the batteries has a higher SOC than one or more different batteries.

The balancing of the two or more batteries may result in one or more low-rate batteries having a higher SOC than one or more high-rate batteries. For example, the one or more low-rate batteries may have SOC which is 5% or more higher than one or more high-rate batteries, such as 10% or more, 15% or more, 20% or more, 30% or more, 50% or more.

The balancing of the two or more batteries may result in one or more high-capacity batteries having a higher SOC than one or more low-capacity batteries. For example, the one or more high-capacity batteries may have SOC which is 5% or more higher than one or more low-capacity batteries, such as 10% or more, 15% or more, 20% or more, 30% or more, 50% or more.

The balancing of the two or more batteries may result in one or more low rate, high-capacity batteries having a higher SOC than one or more high rate, low-capacity batteries. For example, the one or more low rate, high-capacity batteries may have SOC which is 5% or more higher than one or more high rate, low-capacity batteries, such as 10% or more, 15% or more, 20% or more, 30% or more, 50% or more.

By balancing the two or more batteries, the system keeps the SOC of each of the two or more batteries in an optimal range while utilising the full available capacity of the cells. For example, a high-rate battery may operate most efficiently at a SOC of from 20 to 80% while a low-rate battery may operate efficiently across all SOC, and so the system may balance the two or more batteries to keep the two or more batteries within their optimal SOC range.

In this way, the low-rate, high-capacity battery may be balanced to have a higher SOC than the high-rate, low capacity battery. This permits the low-rate battery to provide effective long-term performance, high up-times and good efficiency. It also allows the high-rate battery to be ready to receive power during fast charging.

The controller is typically for balancing the two or more batteries while simultaneously providing a constant power from the two or more batteries to the load or providing a constant power from the power source to the two or more batteries. Typically, the controller provides a constant power from the source to the batteries or to the load from the batteries, in preference to balancing of the two or more batteries. In other words, the controller is primarily for providing a constant power from the two or more batteries to the load or providing a constant power from the power source to the two or more batteries and is secondarily for balancing of the two or more batteries.

In one embodiment, when the system is for discharging multiple batteries to a load, the controller is for balancing the batteries by controlling a transfer of power from a high-rate battery to a low-rate battery. In this way, a high-rate battery may be charged at a high-rate, and while the multiple batteries are discharged at a lower rate, the high-rate battery may be discharged to the low-rate battery to balance the low-rate and high-rate batteries.

The high-rate battery may be charged at a high rate (e.g., using a charger, a regenerative braking system, solar power), and then power may be transferred from the high-rate battery to the low-rate battery to balance the batteries.

In some embodiments, the controller balances the batteries by controlling a transfer of power between the batteries. In such systems, the two or more batteries are in electrical communication.

The power may be transferred from a high-rate battery to a low-rate battery, such as from a high-rate, low-capacity battery to a low-rate, high-capacity battery. The rate of power transfer between the batteries is typically controlled such that the total rate of power transfer is less than the maximum operable charge and/or discharge rate of both batteries. The maximum operable charge and/or discharge rate of both batteries may be a calibrated limit specific to the battery. The total rate of power transfer is taken as the sum of the power transfer to/from a load/source and the power transfer between the batteries.

If the power transfer to/from a load/source is at or close to the maximum operable charge and/or discharge rate, then the transfer between the batteries for balancing may be disabled.

The transfer from a high-rate battery to a low-rate battery may be controlled such that the rate of transfer is less than the maximum operable charge rate of the low-rate battery and is less than the maximum operable discharge rate of the high-rate battery.

The controller adjusts the discharge or charge rate in a similar way to the rate adjustment described herein, except the adjustment is to provide batteries which are balanced.

Preferably, the controller:
(i) receives data on the battery balance; and
(ii) adjusts the rate of discharge or rate of charge of the batteries to move the data on the battery balance to keep the data inside a target range or to move the data towards the target range.

The controller adjusts the transfer of power between the two or more batteries in a similar way to the rate adjustment described herein, except the rate of power transfer is adjusted to provide batteries which are balanced.

Preferably, the controller:
(i) receives data on the battery balance; and
(ii) adjusts the rate of power transfer between the batteries to move the data on the battery balance to keep the data inside a target range or to move the data towards the target range.

The data on the battery balance may comprise SOC (e.g., battery voltage).

The controller may collect information on any or all of voltage, current, state of charge, and temperature of the batteries and/or the input or output power.

The power converter may further comprise a battery management system (BMS). The BMS is typically in electronic communication with the battery. The BMS may be part of the battery. The BMS typically controls the discharging and charging of individual or groups of electrochemical cells, the balancing of the cells, and measures data about the cells and/or the charging engine. The BMS may include similar components as the power converter, as described herein.

Alternatively, the power converter may be separate from the BMS. The controller may be in communication with power converter, such that the controller is for adjusting the rate of discharge or charge of the batteries in response to data receivable from the batteries using the power converter. In this way, the controller and power converter can control the rate of charge/discharge without requiring intervention from the BMS.

The controller may compare the data on the condition of the two or more batteries against a range. If the data is temperature, the controller compares the temperature data against an acceptable temperature range. For example, if the temperature of the battery is 30° C. and the range is from 10 to 50° C. then the temperature data is inside the acceptable range. Alternatively, if the temperature of the battery is 60° C. and the range is 10 to 50° C. then the temperature data is outside the acceptable range.

In other words, the rate of power transfer is controlled so as to maintain the temperature inside an acceptable range, and to minimise the heating and the thermal cycling of the batteries. This prolongs the long-term performance of the batteries. As a result of the control, the heat and thermal cycling is distributed more equally between the two or more batteries in the system.

The range may be a predetermined range. The predetermined range may be recorded in the controller. The predetermined range may be based on the composition of the battery. The predetermined range may be determined by tests on the battery.

The range may be a variable range. The variable range may depend on external factors, such as external temperature. For example, if the external temperature increases (e.g. from 30° C. to 31° C. or more) then the variable range may be changed (e.g. the acceptable cell temperature range may be reduced from 10 to 50° C. to from 10 to 40° C. or the acceptable current range per cell may be reduced from 4 to 10 A to from 4 to 8 A) to avoid overheating. Similarly, for example, if the external temperature is reduced (e.g. from 5° C. to 4° C. or less), the variable range may be changed (e.g. the acceptable temperature range may be changed from 10 to 50° C. to 5 to 50° C. or the acceptable current range changed from 4 to 10 A to from 2 to 10 A) to avoid damaging the battery.

In other words, when the external temperature is above or below the optimal operating temperature of the battery the acceptable power (current) transferred from the cells is reduced.

In addition, when the external temperature is below the optimal operating temperature of the battery the battery may undergo a pre-conditioning routine. The pre-conditioning routine is typically a step which increases the internal temperature of the batteries. The pre-conditioning routine may transfer power between the two or more batteries to increase the temperature of batteries. The power may be transferred back and forth between the two or more batteries. The transfer of power between the two or more batteries may be carried out in a similar way as the balancing of the two or more batteries, as described above. This ensures the heat is shared more equally between the two or more batteries in the system.

The variable range may depend on the voltage of the battery cell or the state of charge of the battery. For example, if the voltage of the battery is reduced (e.g. from over 2.4V to 2.3V or less) then the variable range may be changed (e.g. the acceptable current range may be changed from 4 to 10 A to from 4 to 8 A) to avoid damaging the battery when at a lower state of charge.

The variable range may depend on the load or the source. Information about the load or source may be manually provided to the charging device (e.g. by a user input). Alternatively, the load or source may communicate with the controller of the charging device (e.g. by electronic communication, wireless communication, etc.). As explained below, the variable range may be determined by data from load or source.

The variable range may operate on a discrete scale. Preferably, the variable range may operate on a continuous scale.

The charging device may comprise means to measure the external factors which affect the variable range.

In some embodiments, the controller:
(i) receives data on the power demand of the load or the power supply from the source;
(ii) receives data on the condition of the two or more batteries;
(iii) determines which of the two or more batteries can supply power to the load or can receive power from the source;
(iv) adjusts the rate of discharge or rate of charge of the two or more batteries to provide a constant power from the two or more batteries to the load or from the source to the two or more batteries;
(v) repeats steps (i)-(iv) until the controller signals the power converter to stop discharging or charging the battery.

In embodiments where the system is discharging to a load, the controller:
(i) receives data on the power demand of the load;
(ii) receives data on the condition of the two or more batteries;
(iii) determines which of the two or more batteries can supply power to the load;
(iv) adjusts the rate of discharge of the two or more batteries to provide a constant power from the two or more batteries to the load;
(v) repeats steps (i)-(iv) until the controller signals the power converter to stop discharging the battery.

In embodiments where the system is charging from a source, the controller:
(i) receives data on the power supply from the source;
(ii) receives data on the condition of the two or more batteries;
(iii) determines which of the two or more batteries can receive power from the source;
(iv) adjusts the rate of charge of the two or more batteries to provide a constant power from the source to the two or more batteries;
(v) repeats steps (i)-(iv) until the controller signals the converter to stop discharging or charging the battery.

The controller may receive data on the power demand of the load or the power supply from the source. The data from the load or source typically relate to the power demanded by the load or the power supplied by the source. This may include data on if the source provides AC or DC power, the voltage of the power, the frequency (for AC power), the current of the power.

The controller may receive data on the condition of the two or more batteries. This data is as described above.

The controller may determine which of the two or more batteries can discharge power to the load. The controller typically considers which of the batteries has sufficiently high charge (e.g. SOC), sufficient rate capacity (e.g. maximum discharge rate) and sufficient total capacity to provide the power to the load.

Where the system includes a high-rate battery and a low-rate battery, the controller may determine that the high-rate battery is discharged when the power demand is high and that the low-rate battery is discharged when the power demand is low. For example, the controller may determine that the high-rate battery is discharged during spikes in demand (e.g. when demand is high) and that the low-rate battery is discharged during normal operation (e.g. when demand is low).

Analogously, the controller may determine that the high-rate battery is charged when the power supplied is high and that the low-rate battery is charged when the power supplied is low. For example, the controller may determine that the high-rate battery is charged during spikes in demand (e.g. when demand is high) and that the low-rate battery is charged during normal operation (e.g. when demand is low).

In some embodiments, the controller may determine that the first-life battery is charged or discharged when the power demand is high and that the second-rate battery is charged or discharged when the power demand is low.

A spike in demand or supply may be characterised by a sudden increase in the magnitude of the power demand or supply from normal level. The sudden increase in magnitude may be followed by a sudden decrease in magnitude, to return the demand or supply to the normal level.

The controller typically determines which battery to discharge or charge based on the data received regarding the power demanded from the load or power supplied by the source. The controller may compare power demanded or power supplied to a threshold value for each battery. If the power demanded or supplied is above the threshold value for the low-rate battery the controller may activate the high-rate battery. If the power demanded or supplied is below the threshold value for the high-rate battery the controller may activate the low-rate battery. The threshold value may be predetermined. Alternatively, the threshold value may be calculated by the controller based on the performance of the battery.

During discharging, the controller may determine that the high-rate battery is preferentially discharged when the power demand is high. The high-rate battery may be a niobium-containing metal oxide based battery.

The controller preferably simultaneously discharges both of the high-rate and low-rate batteries. When power demand is high, the controller may determine that 50% or more of discharge is from the high-rate battery and 50% or less of discharge is from the low-rate battery. Preferably when power demand is high, the controller determines that 60% or more, 70% or more, 80% or more, or 90% or more of discharge is from the high-rate battery and that 40% or less, 30% or less, 20% or less, 10% or less of discharge is from the low-rate battery. For example, when power demand is high, the controller determines that 80% or more of discharge is from the high-rate battery and 20% or less is from the low-rate battery.

During discharging, the controller may determine that the low-rate battery is preferentially discharged when the power demand is low.

When power demand is low, the controller may determine that 50% or less of discharge is from the high-rate battery and 50% or more of discharge is from the low-rate battery. Preferably when power demand is low, the controller determines that 40% or less, 30% or less, 20% or less, 10% or less of discharge is from the high-rate battery and that 60% or more, 70% or more, 80% or more, or 90% or more of discharge is from the low-rate battery. For example, when power demand is high, the controller determines that 20% or less of discharge is from the high-rate battery and 80% or more is from the low-rate battery.

During charging, the controller may determine that the high-rate battery is preferentially charged when the power supplied is high. The high-rate battery may be a niobium-containing metal oxide based battery.

The controller preferably simultaneously charges both of the high-rate and low-rate batteries. When power demand is high, the controller may determine that 50% or more of charge goes to the high-rate battery and 50% or less of charge goes to the low-rate battery. Preferably when power demand is high, the controller determines that 60% or more, 70% or more, 80% or more, or 90% or more of charge does goes to the high-rate battery and that 40% or less, 30% or less, 20% or less, 10% or less of discharge goes to the low-rate battery. For example, when power demand is high, the controller determines that 80% or more of charge goes to the high-rate battery and 20% or less of charge goes to the low-rate battery.

During charging, the controller may determine that the low-rate battery is preferentially charged when the power supplied is low.

When power demand is low, the controller may determine that 50% or less of charge goes to the high-rate battery and 50% or more of charge goes to the low-rate battery. Preferably when power demand is low, the controller determines that 40% or less, 30% or less, 20% or less, 10% or less of charge goes to the high-rate battery and that 60% or more, 70% or more, 80% or more, or 90% or more of charge goes to the low-rate battery. For example, when power demand is high, the controller determines that 20% or less of charge goes to the high-rate battery and 80% or more of charge goes to the low-rate battery.

The controller may determine which of the two or more batteries can charge from the source. The controller typically considers which of the batteries has a sufficiently low charge (e.g. SOC), sufficient rate capacity (e.g. maximum charge rate) and sufficient total remaining capacity to receive power from the source.

Where the system includes a high-rate battery and a low-rate battery, the controller may determine that the high-rate battery is charged when the power source provides high power and that the low-rate battery is charge when the power source provides low power.

During charging, where one of the batteries is a niobium-containing metal oxide based battery, the controller may determine that the niobium-containing metal oxide based battery is charged when the power source provides high power.

The controller may simultaneously charge both the high-rate and low-rate batteries. When power supply is high, the controller may determine that 50% or more of charge goes to the high-rate battery and 50% or less of charge goes to the low-rate battery. Preferably when power supply is high, the controller determines that 60% or more, 70% or more, 80% or more, or 90% or more of charge does goes to the high-rate battery and that 40% or less, 30% or less, 20% or less, 10% or less of discharge goes to the low-rate battery. For example, when power supply is high, the controller determines that 80% or more of charge goes to the high-rate battery and 20% or less of charge goes to the low-rate battery.

When power supply is low, the controller may determine that 50% or less of charge goes to the high-rate battery and 50% or more of charge goes to the low-rate battery. Preferably when power supply is low, the controller determines that 40% or less, 30% or less, 20% or less, 10% or less of charge goes to the high-rate battery and that 60% or more, 70% or more, 80% or more, or 90% or more of charge goes to the low-rate battery. For example, when power supply is high, the controller determines that 20% or less of charge goes to the high-rate battery and 80% or more of charge goes to the low-rate battery.

The power demand may be high if the power is such that the high-rate battery provides that power by discharging at a rate of 3 C or more, preferably 5 C or more, more preferably 10 C or more, even more preferably 20 C or more. The power supply may be high if the power is such that the high-rate battery receiving that power is charging at a rate of 3 C or more, preferably 5 C or more, more preferably 10 C or more, even more preferably 20 C or more.

The power demand may be low if the power is such that the high-rate battery provides that power by discharging at a rate of 3 C or less, 2 C or less, 1 C or less, or 0.5 C or less. The power supply may be low if the power is such that the high-rate battery receiving that power is charging at a rate of 3 C or less, 2 C or less, 1 C or less, or 0.5 C or less.

The step of adjusting the discharge or charge rate of the battery to increase the discharge rate in response to data from the receiver battery can be described in the same way as above.

Increasing or decreasing the rate of discharge is typically carried out by the controller signalling to the power converter to increase or decrease the discharge rate. The power converter may increase or decrease the discharge rate by any suitable means, such as changing the current of the output power or changing the voltage of the output power.

Step (v) of repeating steps steps (i)-(iv) until the controller signals the power converter to stop discharging/charging typically involves repeating steps (i)-(iv) in order to continuously adjust the rate of discharge or charge. This allows the system to be responsive to the load or source, providing the optimum charge or discharge without damaging the battery and without discharging or charging unsafely.

The steps may be repeated every 0.01 to 10 seconds, preferably from 0.1 to 1 seconds, more preferably from 0.2 to 0.5 seconds. The frequency of the data sending step is about every 0.25 seconds.

### Method

The invention provides a method of discharging multiple batteries to a load, or charging multiple batteries from a source, using a system comprising:
two or more batteries wherein two of the batteries are different;
a power connector electrically connecting the batteries to the load or the source;
a power converter in electrical communication with the batteries and the power connector, wherein the power converter independently controls the rate of discharge or charge of each of the batteries; and
a controller in communication with the batteries and the power converter, and the method comprising the steps of:
discharging the batteries to the load, or charging the batteries from the source, using the power converter and power connector,
sending data on the condition of the batteries to the controller, and
adjusting the discharge rate or the charge rate of the batteries in response to the data from the batteries, to provide a constant power from the batteries to the load or from the source to the batteries.

The system used in the method may be as described herein. The description of the system is also applicable to the method.

The method comprises a step of discharging the batteries to the load, or charging the batteries from the source, using the power converter and power connector. This step may be known as the “discharging or charging step”.

In the discharging step, the batteries are discharged through the power converter to the power connector, to provide power to the load connected to the power connector. In the charging step, the batteries are charged from a power supply connected to the power connector through the power converter.

Preferably the two or more batteries are discharged simultaneously to the load or are charged simultaneously from the source.

The initial discharge or charge rate may be determined by the controller. The initial discharge or charge rate may be determined based on the demand from the load or supply from the source. The initial discharge or charge rate may be pre-determined by information on the batteries stored in the controller. The initial discharge or charge rate may be determined by previous data on discharging or charging the batteries.

Typically, the controller initiates discharging or charging by communication with the power converter. The power converter may activate using a switching device to start charging or discharging.

The method comprises a step of sending data on the condition of the batteries to the controller. This step may be known as the “data sending step”.

In the data sending step, the controller receives data from the two or more batteries. Preferably the controller receives data from each of the two or more batteries. The data from the two or more batteries can be used to indicate the condition of the two or more batteries during discharging or charging. The data from the two or more batteries can be used to indicate the condition of each battery during discharging or charging.

In the data sending step, the controller may receive data from the power converter. The data from the power converter can be used to indicate the condition of the two or more batteries during discharging or charging. The data may also be used to indicate the condition of the power converter(s).

The data in the data sending step is typically selected from the list comprising at least one of battery voltage, battery temperature, battery isolation resistance, discharge current, state of charge of the electrochemical cells, state of balancing of the electrochemical cells, and power availability of the battery.

Preferably the data comprises voltage and temperature. More preferably the data comprises voltage, current, and temperature.

The data may be sent to the controller by any suitable means known in the art, such as by electronic communication.

The data may be processed before sending to the controller. The data may be processed by the BMS or power converter, and then sent to the controller. Alternatively, unprocessed data may be sent to the controller, and the data may be processed by the controller.

The data is preferably sent frequently enough to determine the condition of the two or more batteries. The data is preferably sent frequently enough to determine the demand of the load or the power provided from the source. The frequency refers to how often the data is sent from the battery and power controller to the controller. The frequency may also refer to the measurement frequency of the data at the battery and power converter. Data may be sent to the controller at a frequency of from 0.01 to 10 seconds, preferably from 0.1 to 1 seconds, more preferably from 0.2 to 0.5 seconds, such as about 0.25 seconds.

The method comprises a step of adjusting the discharge rate or the charge rate of the batteries in response to the data from the batteries, to provide a constant power from the batteries to the load or from the source to the batteries. This step may be known as the “rate adjustment step”.

The constant power in the rate adjustment step is as described above in relation to the system.

In the rate adjustment step, the controller responds to data from the batteries by adjusting the discharge rate (or the charge rate) of the two or more batteries. Typically, the controller compares the data on the condition of each battery against an acceptable range and determines if the discharge rate should be increased or decreased. Typically, the controller also compares the data on the demand from the load and/or the power supply from the source and determines which of the batteries should be discharged or charged to provide power to the load or receive power from the source. The controller signals to the power converter to increase or decrease the rate of discharge or charge for each of the two or more batteries.

The controller may start and stop charging and discharging of the charging device battery. The controller may receive a signal to start and/or stop charging and discharging.

The signal may be from the load or source, a user interface, or another input. The controller may detect when a connection is made to the power input or output, in order to start charging or discharging. The controller may detect when a connection is removed from the power input or output, in order to stop charging or discharging.

The controller may receive data sent from a load. The data may be the same as that sent to the controller from the battery of the system. The controller may receive data from the load and then signal to the power converter to output power, based on the data.

The controller may receive data sent from the source. The data may include if the source provides AC or DC power, the voltage of the power, the frequency (for AC power), the current of the power. The controller may then signal to the power converter how to treat the input power, based on the data from the source.

The controller may also receive data about the state of charge (e.g. voltage) of individual or groups of electrochemical cells comprised in the two or more batteries. This data may then be used by the controller to balance the cells in the two or more batteries. Improved balancing may reduce the amount of overvoltage or undervoltage of any individual cell, which in turn reduces potential damage to the cells. The controller typically balances the cells while the battery is discharging, which can improve the discharge rate of the battery as the stress on the battery is reduced due to the improved balancing of the cells. The controller may balance the electrochemical cells of the one or more of the batteries. The controller may discharge individual or groups of electrochemical cells of the battery, thereby balancing the electrochemical cells of the battery. The controller may increase the rate of discharge for cells having a higher state or charge (e.g. higher voltage) and/or decrease the rate of discharge for cells having a lower state of charge (e.g. lower voltage).

In the rate adjustment step, the controller may independently adjust the discharge or charge rate of two or more of the batteries. This may in turn balance the two or more batteries. This may be known as a “balancing step”.

In addition, in the balancing step the controller may balance the batteries by independently adjusting the discharge or charge rate of two or more of the batteries and/or by transferring power between the two or more batteries.

In some embodiments, the method further comprises
balancing the batteries by independently adjusting the discharge or charge rate of the two or more of the batteries using the controller; and/or
balancing the batteries by transferring power between the two or more batteries, wherein the two or more batteries are electrically connected

The balancing step may balance the batteries during charging and discharging of the two or more batteries, by adjusting the discharge or charge rate of the two or more batteries independently. Adjusting the relative discharge or charge rate of the two or more batteries allows one battery to be discharged/charged quicker relative to another battery, to change the relative SOC of the two or more batteries. The relative discharge or charge rate of the two or more batteries is adjusted such that the batteries provide a constant power to the load or receive a constant power from the source. The relative discharge or charge rate of the two or more batteries is typically adjusted such that data on the condition of the two or more batteries is maintained within an acceptable range.

In addition or alternatively, the balancing step may balance the batteries by transferring power between the two or more batteries. This may occur while the batteries are charging and discharging (e.g., when the system is providing power to a load or receiving power from a source) or when the system is not providing or receiving power.

In some embodiments, when discharging the multiple batteries to a load the balancing step may balance the batteries by independently adjusting the discharge rate of two or more of the batteries and/or by transferring power between the two or more batteries. Preferably during discharge of the multiple batteries to a load the balancing step balances the batteries by transferring power between the two or more batteries.

In some embodiments, when charging the multiple batteries from a source the balancing step may balance the batteries by independently adjusting the charge rate of the two or more of the batteries and/or by transferring power between the two or more batteries. Preferably during charging of the multiple batteries from a source the balancing step balances the batteries by independently adjusting the charge rate of the two or more of the batteries.

In a preferred embodiment, when charging the multiple batteries from a source the balancing step balances the batteries by independently adjusting the charge rate of the two or more of the batteries and then when discharging the multiple batteries to a load the controller balances the batteries by transferring power between the two or more batteries.

Balancing of the two or more batteries typically refers to adjusting the state of charge of the two or more batteries such that they have substantially the same state of charge (SOC). Accordingly, balancing of the two or more batteries results in the two or more batteries having a more similar SOC than before balancing. The balancing of the two or more batteries may result in the two or more batteries having a SOC which differs by less than a certain amount, such as a SOC which differs by ±20% or less, preferably ±15% or less, more preferably ±10% or less, even more preferably ±5% or less.

Alternatively, balancing of the two or more batteries may refer to adjusting the state of charge of the two or more batteries such that they have an optimal state of charge. The optimal state of charge may depend on aspects of the battery, such as the electrical properties, chemical properties, physical properties, structural properties or electrochemical properties. The optimal state of charge may depend on the maximum operable charge and/or discharge rate of the battery, and/or the maximum capacity of the battery.

The optimal state of charge may be a predetermined optimal state of charge (SOC) range. For example, the one or more low-rate batteries may have an optimal SOC range which is 0 to 100%, while the one or more high-rate batteries may have an optimal SOC range which is 20 to 80%. The optimal SOC range may be adapted by the intended use of the system. For example, where the system is used in an electric vehicle the one or more low-rate batteries may have an optimal SOC range which is 50 to 100%, while the one or more high-rate batteries may have an optimal SOC range which is 20 to 50%. In this way, the low-rate battery has a high SOC to store the majority of the energy needed to power the vehicle, while the high-rate battery has a low SOC so it is ready to accept energy from a fast charger or regenerative braking system.

The optimal state of charge may be a predetermined difference in the SOC between the batteries. The balancing of the two or more batteries may result in the two or more batteries having a SOC where one or more of the batteries has a higher SOC than one or more different batteries. The balancing of the two or more batteries may result in the two or more batteries having a SOC where one or more of the batteries has a higher SOC than one or more different batteries.

The balancing of the two or more batteries may result in one or more low-rate batteries having a higher SOC than one or more high-rate batteries. For example, the one or more low-rate batteries may have SOC which is 5% or more higher than one or more high-rate batteries, such as 10% or more, 15% or more, 20% or more, 30% or more, 50% or more.

The balancing of the two or more batteries may result in one or more high-capacity batteries having a higher SOC than one or more low-capacity batteries. For example, the one or more high-capacity batteries may have SOC which is 5% or more higher than one or more low-capacity batteries, such as 10% or more, 15% or more, 20% or more, 30% or more, 50% or more.

The balancing of the two or more batteries may result in one or more low rate, high-capacity batteries having a higher SOC than one or more high rate, low-capacity batteries. For example, the one or more low rate, high-capacity batteries may have SOC which is 5% or more higher than one or more high rate, low-capacity batteries, such as 10% or more, 15% or more, 20% or more, 30% or more, 50% or more.

By balancing the two or more batteries, the method keeps the SOC of each of the two or more batteries in an optimal range while utilising the full available capacity of the cells. For example, a high-rate battery may operate most efficiently at a SOC of from 20 to 80% while a low-rate battery may operate efficiently across all SOC, and so the method may balance the two or more batteries to keep the two or more batteries within their optimal SOC range.

In this way, the low-rate, high-capacity battery may be balanced to have a higher SOC than the high-rate, low-capacity battery. This permits the low-rate battery to provide effective long-term performance, high up-times and good efficiency. It also allows the high-rate battery to be ready to receive power during fast charging.

The balancing step is typically for balancing the two or more batteries while simultaneously providing a constant power from the two or more batteries to the load or providing a constant power from the power source to the two or more batteries. Typically, the method provides a constant power from the source to the batteries or to the load from the batteries, in preference to balancing of the two or more batteries. In other words, the method carries out the adjustment step in preference to the balancing step. The method comprises a primary step of providing a constant power from the two or more batteries to the load or providing a constant power from the power source to the two or more batteries, and a secondary step of balancing the two or more batteries.

In one embodiment, when the method is a method of discharging multiple batteries to a load, the method comprises balancing the batteries by controlling a transfer of power from a high-rate battery to a low-rate battery. In this way, a high-rate battery may be charged at a high-rate, and while the multiple batteries are discharged at a lower rate, the high-rate battery may be discharged to the low-rate battery to balance the low rate and high-rate batteries.

The high-rate battery may be charged at a high rate (e.g., using a charger, a regenerative braking system, or solar power), and then power may be transferred from the high-rate battery to the low-rate battery to balance the batteries.

In some embodiments, the controller balances the batteries by controlling a transfer of power between the batteries. In such methods, the two or more batteries are in electrical communication.

The power may be transferred from a high-rate battery to a low-rate battery, such as from a high-rate, low-capacity battery to a low-rate, high-capacity battery. The rate of power transfer between the batteries is typically controlled such that the rate of transfer is less than the maximum operable charge and/or discharge rate of both batteries. For example, a transfer from a high-rate battery to a low-rate battery is controlled such that the rate of transfer is less than the maximum operable charge rate of the low-rate battery and is less than the maximum operable discharge rate of the high-rate battery.

The step of adjusting the discharge or charge rate is carried out in a similar way to the adjustment step described herein, except the adjustment is to provide batteries which are balanced.

Preferably, the balancing step comprises the steps of:
(i) receiving data on the battery balance; and
(ii) adjusting the rate of discharge or rate of charge of the batteries to move the data on the battery balance to keep the data inside a target range or to move the data towards the target range.

The step of transferring power between the two or more batteries is carried out in a similar way to the adjustment step described herein, except the rate of power transfer is adjusted to provide batteries which are balanced.

Preferably, the balancing step comprises the steps of:
(i) receiving data on the battery balance; and
(ii) adjusting the rate of power transfer between the batteries to move the data on the battery balance to keep the data inside a target range or to move the data towards the target range.

The data on the battery balance may be SOC (e.g., battery voltage).

In the rate adjustment step, the controller may collect information on any or all of voltage, current, state of charge, and temperature of the batteries and/or the input or output power.

In the rate adjustment step the controller may compare the data on the condition of the two or more batteries against a range. If the data is temperature, the controller compares the temperature data against an acceptable temperature range. For example, if the temperature of the battery is 30° C. and the range is from 10 to 50° C. then the temperature data is inside the acceptable range. Alternatively, if the temperature of the battery is 60° C. and the range is 10 to 50° C. then the temperature data is outside the acceptable range.

The range may be a predetermined range. The predetermined range may be recorded in the controller. The predetermined range may be based on the composition of the battery. The predetermined range may be determined by tests on the battery.

The range may be a variable range. The variable range may depend on external factors, such as external temperature. For example, if the external temperature increases (e.g. from 30° C. to 31° C. or more) then the variable range may be changed (e.g. the acceptable cell temperature range may be reduced from 10 to 50° C. to from 10 to 40° C. or the acceptable current range per cell may be reduced from 4 to 10 A to from 4 to 8 A) to avoid overheating. Similarly, for example, if the external temperature is reduced (e.g. from 5° C. to 4° C. or less), the variable range may be changed (e.g. the acceptable temperature range may be changed from 10 to 50° C. to 5 to 50° C. or the acceptable current range changed from 4 to 10 A to from 2 to 10 A) to avoid damaging the battery.

In addition, when the temperature of the battery is below the optimal operating temperature of the battery the battery may undergo a pre-conditioning step. The pre-conditioning step is typically a step which increases the internal temperature of the batteries. The pre-conditioning step is typically carried out before the step of discharging the batteries to the load, or charging the batteries from the source. The pre-conditioning routine may transfer power between the two or more batteries to increase the temperature of batteries. The power may be transferred back and forth between the two or more batteries. The transfer of power between the two or more batteries may be carried out in a similar way to the balancing of the two or more batteries, as described above. This means the heat is shared more equally between the two or more batteries in the system, such that two or more batteries are provided at their optimal operating temperature.

The variable range may depend on the voltage of the battery cell or the state of charge of the battery. For example, if the voltage of the battery is reduced (e.g. from over 2.4V to 2.3V or less) then the variable range may be changed (e.g. the acceptable current range may be changed from 4 to 10 A to from 4 to 8A) to avoid damaging the battery when at a lower state of charge.

The variable range may depend on the load or the source. Information about the load or source may be manually provided to the charging device (e.g. by a user input). Alternatively, the load or source may communicate with the controller of the charging device (e.g. by electronic communication, wireless communication, etc.). As explained below, the variable range may be determined by data from load or source.

The variable range may operate on a discrete scale. Preferably, the variable range may operate on a continuous scale.

The charging device may comprise means to measure the external factors which affect the variable range.

Preferably, the rate adjustment step comprises the steps of:
(i) receiving data on the power demand of the load or the power supply from the source;
(ii) receiving data on the condition of the batteries;
(iii) determining which of the batteries can supply power to the load or can receive power from the source based on the data on the condition of the batteries;
(iv) adjusting the rate of discharge or rate of charge of the batteries to provide a constant power from the batteries to the load or from the source to the batteries;
(v) repeating steps (i)-(iv) until the controller signals the power converter to stop discharging or charging the batteries.

In embodiments where the system is discharging to a load, the rate adjustment step comprises the steps of:
(i) receiving data on the power demand of the load;
(ii) receiving data on the condition of the two or more batteries;
(iii) determining which of the two or more batteries can supply power to the load;
(iv) adjusting the rate of discharge of the two or more batteries to provide a constant power from the two or more batteries to the load;
(v) repeating steps (i)-(iv) until the controller signals the power converter to stop discharging the battery.

In embodiments where the system is charging from a source, the rate adjustment step comprises the steps of:
(i) receiving data on the power supply from the source;
(ii) receiving data on the condition of the two or more batteries;
(iii) determining which of the two or more batteries can receive power from the source;
(iv) adjusting the rate of charge of the two or more batteries to provide a constant power from the source to the two or more batteries;
(v) repeating steps (i)-(iv) until the controller signals the converter to stop discharging or charging the battery.

In the rate adjustment step the controller may receive data on the power demand of the load or the power supply from the source. The data from the load or source typically relate to the power demanded by the load or the power supplied by the source. This may include data on if the source provides AC or DC power, the voltage of the power, the frequency (for AC power), the current of the power.

In the rate adjustment step the controller may receive data on the condition of the two or more batteries. This data is as described above.

In the rate adjustment step the controller may determine which of the two or more batteries can discharge power to the load. The controller typically considers which of the batteries has sufficiently high charge (e.g. SOC), sufficient rate capacity (e.g. maximum discharge rate) and sufficient total capacity to provide the power to the load.

Where the system includes a high-rate battery and a low-rate battery, the controller may determine that the high-rate battery is discharged when the power demand is high and that the low-rate battery is discharged when the power demand is low. For example, the controller may determine that the high-rate battery is discharged during spikes in demand (e.g. when demand is high) and that the low-rate battery is discharged during normal operation (e.g. when demand is low).

Analogously, the controller may determine that the high-rate battery is charged when the power supplied is high and that the low-rate battery is charged when the power supplied is low. For example, the controller may determine that the high-rate battery is charged during spikes in demand (e.g. when demand is high) and that the low-rate battery is charged during normal operation (e.g. when demand is low).

In some embodiments, in the rate adjustment step the controller may determine that the first-life battery is charged or discharged when the power demand is high and that the second-rate battery is charged or discharged when the power demand is low.

A spike in demand or supply may be characterised by a sudden increase in the magnitude of the power demand or supply from normal level. The sudden increase in magnitude may be followed by a sudden decrease in magnitude, to return the demand or supply to the normal level.

In the rate adjustment step the controller typically determines which battery to discharge or charge based on the data received regarding the power demanded from the load or power supplied by the source. The controller may compare power demanded or power supplied to a threshold value for each battery. If the power demanded or supplied is above the threshold value for the low-rate battery the controller may activate the high-rate battery. If the power demanded or supplied is below the threshold value for the high-rate battery the controller may activate the low-rate battery. The threshold value may be predetermined. Alternatively, the threshold value may be calculated by the controller based on the performance of the battery. During discharging, the controller may determine that the high-rate battery is preferentially discharged when the power demand is high. The high-rate battery may be a niobium-containing metal oxide based battery.

The controller preferably simultaneously discharges both of the high-rate and low-rate batteries. When power demand is high, the controller may determine that 50% or more of discharge is from the high-rate battery and 50% or less of discharge is from the low-rate battery. Preferably when power demand is high, the controller determines that 60% or more, 70% or more, 80% or more, or 90% or more of discharge is from the high-rate battery and that 40% or less, 30% or less, 20% or less, 10% or less of discharge is from the low-rate battery. For example, when power demand is high, the controller determines that 80% or more of discharge is from the high-rate battery and 20% or less is from the low-rate battery.

During discharging, the controller may determine that the low-rate battery is preferentially discharged when the power demand is low.

When power demand is low, the controller may determine that 50% or less of discharge is from the high-rate battery and 50% or more of discharge is from the low-rate battery. Preferably when power demand is low, the controller determines that 40% or less, 30% or less, 20% or less, 10% or less of discharge is from the high-rate battery and that 60% or more, 70% or more, 80% or more, or 90% or more of discharge is from the low-rate battery. For example, when power demand is high, the controller determines that 20% or less of discharge is from the high-rate battery and 80% or more is from the low-rate battery.

During charging, the controller may determine that the high-rate battery is preferentially charged when the power supplied is high. The high-rate battery may be a niobium-containing metal oxide based battery.

The controller preferably simultaneously charges both of the high-rate and low-rate batteries. When power demand is high, the controller may determine that 50% or more of charge goes to the high-rate battery and 50% or less of charge goes to the low-rate battery. Preferably when power demand is high, the controller determines that 60% or more, 70% or more, 80% or more, or 90% or more of charge does goes to the high-rate battery and that 40% or less, 30% or less, 20% or less, 10% or less of discharge goes to the low-rate battery. For example, when power demand is high, the controller determines that 80% or more of charge goes to the high-rate battery and 20% or less of charge goes to the low-rate battery.

During charging, the controller may determine that the low-rate battery is preferentially charged when the power supplied is low.

When power demand is low, the controller may determine that 50% or less of charge goes to the high-rate battery and 50% or more of charge goes to the low-rate battery. Preferably when power demand is low, the controller determines that 40% or less, 30% or less, 20% or less, 10% or less of charge goes to the high-rate battery and that 60% or more, 70% or more, 80% or more, or 90% or more of charge goes to the low-rate battery. For example, when power demand is high, the controller determines that 20% or less of charge goes to the high-rate battery and 80% or more of charge goes to the low-rate battery.

In the rate adjustment step the controller may determine which of the two or more batteries can charge from the source. The controller typically considers which of the batteries has a sufficiently low charge (e.g. SOC), sufficient rate capacity (e.g. maximum charge rate) and sufficient total remaining capacity to receive power from the source.

Where the system includes a high-rate battery and a low-rate battery, in the rate adjustment step the controller may determine that the high-rate battery is charged when the power source provides high power and that the low-rate battery is charge when the power source provides low power.

During charging, where one of the batteries is a niobium-containing metal oxide based battery, the controller may determine that the niobium-containing metal oxide based battery is charged when the power source provides high power.

The controller may simultaneously charge both the high-rate and low-rate batteries. When power demand is high, the controller may determine that 50% or more of charge goes to the high-rate battery and 50% or less of charge goes to the low-rate battery. Preferably when power demand is high, the controller determines that 60% or more, 70% or more, 80% or more, or 90% or more of charge does goes to the high-rate battery and that 40% or less, 30% or less, 20% or less, 10% or less of discharge goes to the low-rate battery. For example, when power demand is high, the controller determines that 80% or more of charge goes to the high-rate battery and 20% or less of charge goes to the low-rate battery.

When power demand is low, the controller may determine that 50% or less of charge goes to the high-rate battery and 50% or more of charge goes to the low-rate battery. Preferably when power demand is low, the controller determines that 40% or less, 30% or less, 20% or less, 10% or less of charge goes to the high-rate battery and that 60% or more, 70% or more, 80% or more, or 90% or more of charge goes to the low-rate battery. For example, when power demand is high, the controller determines that 20% or less of charge goes to the high-rate battery and 80% or more of charge goes to the low-rate battery.

The power demand may be high if the power is such that the high-rate battery provides that power by discharging at a rate of 3 C or more, preferably 5 C or more, more preferably 10 C or more, even more preferably 20 C or more. The power supplied may be high if the power is such that the high-rate battery receiving that power is charging at a rate of 3 C or more, preferably 5 C or more, more preferably 10 C or more, even more preferably 20 C or more.

The power demand may be low if the power is such that the high-rate battery provides that power by discharging at a rate of 3 C or less, 2 C or less, 1 C or less, or 0.5 C or less. The power supplied may be low if the power is such that the high-rate battery receiving that power is charging at a rate of 3 C or less, 2 C or less, 1 C or less, or 0.5 C or less.

Increasing or decreasing the rate of discharge is typically carried out by the controller signalling to the power converter to increase or decrease the discharge rate. The power converter may increase or decrease the discharge rate by any suitable means, such as changing the current of the output power or changing the voltage of the output power.

Step (v) of repeating steps (i)-(iv) until the controller signals the power converter to stop discharging/charging typically involves repeating steps (i)-(iv) in order to continuously adjust the rate of discharge or charge. This allows the system to be responsive to the load or source, providing the optimum charge or discharge without damaging the battery and without discharging or charging unsafely.

The steps may be repeated every 0.01 to 10 seconds, preferably from 0.1 to 1 seconds, more preferably from 0.2 to 0.5 seconds. The frequency of the data sending step is about every 0.25 seconds.

### Use

Generally, the invention provides a use of a system for discharging two or more different batteries to a load, or charging two or more different batteries from a source, wherein a power converter independently controls the rate of discharging or charging of the batteries to provide a constant power from the batteries to the load or a constant power from the source to the batteries.

The invention provides a use of the system of the first aspect, for discharging the two or more batteries to a load or charging the two or more batteries from a source.

The system and/or method used is as described herein. The description of the system and method is also applicable to the use of the system.

Two of the batteries have one or more different aspects. The different aspects are as described in relation to the system.

The system may be beneficial in a grid storage system as it will allow for the storage system to comprise multiple different types of batteries, including a mixture of first-life and second-life batteries (where the second-life batteries may already be partly degraded). Furthermore, the system of the invention allows for spikes in both supply and demand, which may arise in grid-scale systems, especially those connected to renewable sources of power (e.g., solar power, wind power).

The system may also be useful in an electric vehicle (EV), since in normal use such a vehicle may also encounter spikes in supply and demand. For example, rapid acceleration may cause a spike in electrical demand which is most beneficially at least partly served by a high-rate battery. Rapid deceleration may likewise cause a spike in electrical supply (e.g. due to regenerative braking) which would be wasted if at least part of it could not be used to charge a high-rate battery.

### Example System

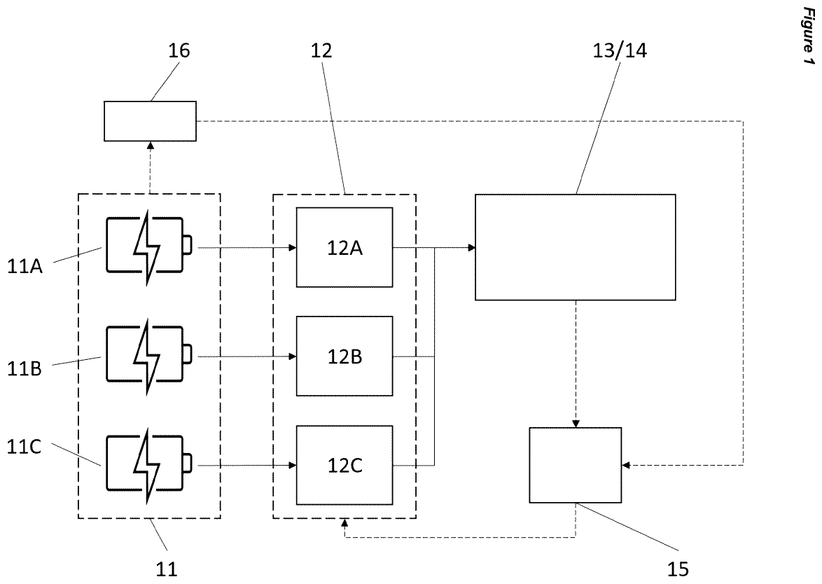

FIG. 1 shows a block diagram of an example of the system during discharge. Three example batteries [11] are shown. The batteries may be fast-charging and/or fast-discharging batteries. For example, the batteries may include a relatively low-capacity battery [11A]; a slow-charging, slow-discharging battery with relatively high capacity [11B]; and a flow battery [11C]. In this case, the first battery [11A] has a relatively low capacity, so it is vulnerable to overcharge or overdischarge. The second battery [11B] has a relatively low charging and discharging speed, it is vulnerable to damage if a load attempts to discharge it at a high rate or a power source attempts to charge it at a high rate. Since the flow battery [11C] operates in an entirely different way to conventional rechargeable batteries, it requires more complex power electronics. This means that the three batteries [11] cannot use identical power electronics to charge and discharge and so in a conventional system they cannot be used together as part of the same conventional system. As a result, it is impossible to take advantage of, for example, the faster discharge of the first battery [11A] alongside the higher capacity of the second battery [11B].

As shown in FIG. 1, each battery [11] is connected to a power converter [12] which is configured for that battery's requirements. Each battery [11A, 11B, 11C] is connected to its respective power converter [12A, 12B, 12C] by an electrical connection. The power converter is also in electrical connection with the load [13]. The electrical connections are shown by a solid line. The converters [12] can adjust power output as required for the load [13] while also cushioning the battery [11] from excessive demand. The converters [12] are connected to the load [13] to supply it with power from the batteries [11].

The converters [12] are preferably capable of acting in both boost and buck modes and may beneficially have an architecture that allows them to act in bidirectional mode. When in boost mode, a converter [12] increases or steps up the voltage of the power flowing through it such that the output voltage is higher than the input voltage. When in buck mode, the converter decreases or steps down the voltage of the power flowing through it such that the output voltage is lower than the input voltage. Boost and buck converter circuits may be separate circuits or may be arranged as a combined system known as a buck-boost converter circuit. In order to act in both boost and buck modes, a converter [12] of the system may comprise a buck-boost circuit or it may comprise separate buck and boost circuits combined with a switching system that allows either one to be used when appropriate.

Sensors [16] connect to the batteries [11] and their power connections and detect parameters such as temperature and pressure around the batteries [11], the state of charge of the batteries [11], and the voltage and current of the power flowing over the power connection. The data collected from the sensors [16] is transmitted to the controller [15] by a signalling connection. Further, there is a signalling connection from the load [13] to the controller. This may transmit information on the power being drawn and, for example, predictions of future power demand that could change the combination of batteries [11] in use. The signalling connections are represented by dashed lines. The controller [15] has a further signalling connection which is connected to the power converters [12] to transmit commands and receive feedback and other information on the behaviour and status of the converters.

The system shown in FIG. 1 may also be used for charging the batteries from a source. During charging, the flow of power would reverse-either flowing through bidirectional converters [12] or through a second set of converters [12]—and the load [13] would be replaced by a power source [14]. For example, a device whose functions are powered by the system could be connected to mains electricity for charging or an electric vehicle could be charged through a regenerative braking system. Accordingly, in a case such as regenerative braking, the system is preferably operable to switch automatically and rapidly between discharge and charge mode.

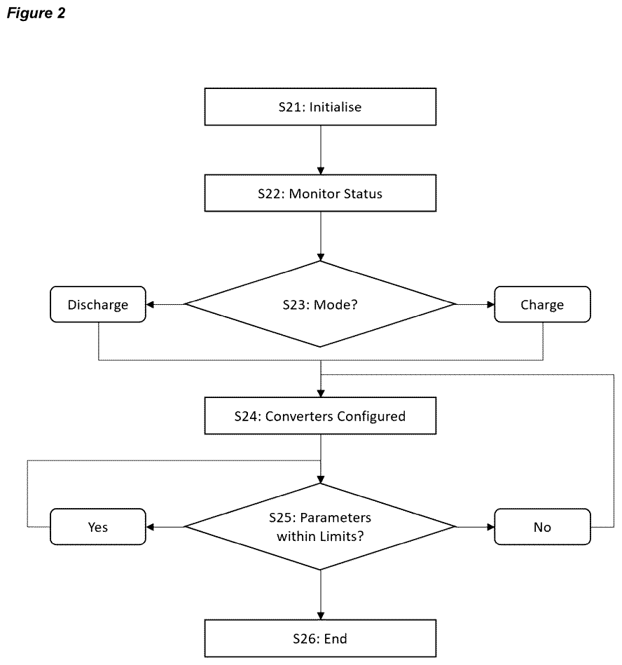

FIG. 2 shows an example flowchart of the algorithm which could be used by the controller to determine the behaviour of the converters [12]. Where relevant, steps will be described twice, once in discharge mode and once in charge mode. Accordingly, the connected external device may act as a load [13] during discharging or as a power source during charging, and accordingly will be referred to with the same reference numbers.

At Step S21, the system is initialised, for example, by being connected to an external device which acts as either a load [13] or a power source [14] through a connection capable of carrying electrical power. The connection may be a power connector.

At Step S22, the controller [15] receives signals from the connected device [13] or the power connector, such as from a plug socket which is used to connect the device [13] or a power switch turning on an external device powered by the batteries [11]. This signal is then used to determine the mode of operation at Step S23.

If at Step S23 the controller [15] determines that the connected device is a load [13] that is drawing power from the batteries [11], the system enters discharge mode as previously described with reference to FIG. 1: the batteries [11] are discharged and power flows from the batteries [11] to the power converters [12] and thence to the device [13].

In discharge mode, at Step S24 the controller [15] transmits a signal to the converters [12] to indicate the direction of power flow. The controller [15] also determines the required rate and voltage of the discharge and transmits signals to the power converters [12] to cause them to enter buck mode or boost mode and/or to activate and deactivate the power converter if a particular battery [11] is not required or is not suitable for the demands of the load [13].

At Step S25, the controller [15] receives a signal from the sensors [16] including data about the status of the batteries [11] and/or the power flowing to the load [13]. The controller [15] can determine the status of the batteries [11] and the power flowing to the load [13]. The status may include information about the temperature, voltage, current, and/or balance of the batteries. The controller [15] then determines the status of the batteries are within appropriate limits, for example whether one or more of the batteries [11] are starting to overheat or whether the state of charge of a battery [11] is falling below a safety threshold. If the parameters are within appropriate limits, the controller [15] takes no action and continues to receive input from the sensors [16]. Otherwise, it sends further signals to the converters to alter their behaviour, for example, to increase current drawn from the battery [11] output or activate a battery [11] that was not previously activated.

In a system where a first battery [11A] is a high-rate battery and a second battery [11B] is a low-rate battery, the respective power converters may be configured to adjust the current and voltage for the different batteries. For example, the power converter [12A] may enter boost mode to increase the voltage from the high-rate battery [11A] to the load and the power converter [12B] may enter buck mode to decrease the voltage from the low-rate battery [11B] to the load. In this way, the rate of discharging the high-rate battery [11A] may be increased to utilise the high-rate discharge, while more slowly discharging the low-rate battery [11B].

Step S25 is repeated until the load [13] is disconnected or, one or more of the batteries [11] are depleted (e.g. 0% SOC) and the power output ends at Step S26.

Alternatively, if at Step S23 the controller [15] determines that the connected device [13/14] is a power source [14] that can be used to charge the batteries [11], the system enters charging mode. The controller [15] therefore signals the converters [12] that they should expect power to flow from the source to the batteries [11]. The power converters are configured to convert the incoming power from the source at Step S24. For example, converters [12] may be put into buck mode to lower the incoming voltage to a voltage that is safe for their respective batteries [11].

In a system where a first battery [11A] is a high-rate battery and a second battery [11B] is a low-rate battery, the respective power converters may be configured to adjust the current and voltage for the different batteries. For example, the power converter [12A] may enter boost mode to increase the voltage to the high-rate battery [11A] and the power converter [12B] may enter buck mode to decrease the voltage to the low-rate battery [11B]. In this way, the rate of charging the high-rate battery [11A] may be increased to utilise the high-rate charging, while more slowly charging the low-rate battery [11B].

While the power is supplied from the power source [14], the controller [15] uses input from the sensors [16] to monitor the status of the converters [12], the batteries [11], and the power source [14] similarly to its behaviour in discharge mode. If the detected parameters are within limits, it does nothing and continues to monitor, repeating Step S25 until the power source is disconnected or the batteries [11] are at 100% SOC, and the power output ends at Step S26.

If the parameters are not within limits, for example because a battery [11] is being charged more rapidly than is safe for its chemistry or because a battery [11] has reached a maximum safe state of charge, the controller [15] signals the converters [12] again, for example to stop the flow of power to the fully-charged battery [11] or to lower the voltage output by the appropriate converter [12].

### Example System Results

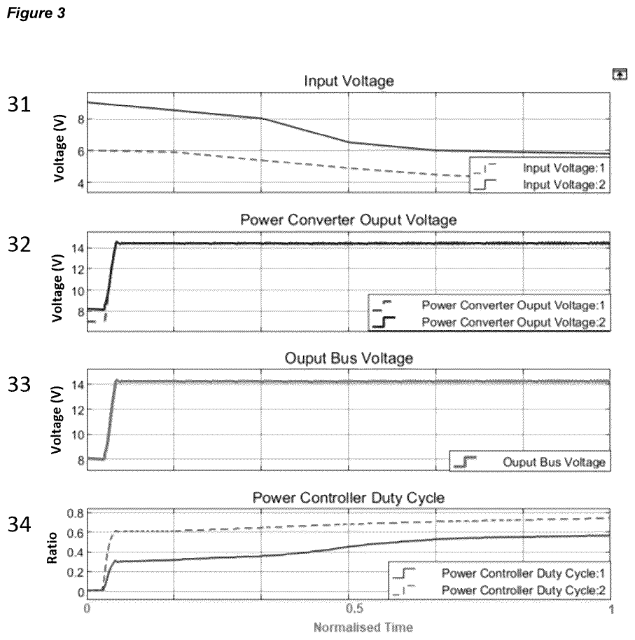

FIG. 3 shows the output of a simulated version of the system connected to two batteries [11A, 11B]. The two batteries output different voltages which change over time. The simulation is carried out over a normalised time frame.

The top graph [31], titled “Input Voltage” shows the voltage of the power output from the batteries [11] and input to the converters [12]. The voltage from the first battery [11A], labelled in the key as Input Voltage 1 and represented by a dashed line, is lower than the voltage from the second battery [11B], labelled in the key as Input Voltage 2 and represented by a solid line. Both battery voltages fall over time at different rates as the discharge rate of the batteries changes to represent the behaviour of the simulated load [13]. This also represents the reducing in voltage as the batteries discharge.

Both batteries [11] are outputting power simultaneously. The system of the invention controls the converters [12] to harmonise their outputs as shown in the second graph [32], titled “Power Converter Output Voltage”, which shows the output of the power converters [12]. This in turn leads to a constant power output from the system to the load [13] as if it came from a single power source, as shown in the third graph [33], titled “Output Bus Voltage”.

The alterations in the behaviour of the converters [12] that lead to this output are shown in the fourth graph [34], titled “Power Controller Duty Cycle”. At the beginning of the simulation, the controller [15] activates the two converters [12A, 12B] at different levels, rendered in the graph [34] as percentages described as decimal values between 0 (0 %) and 1 (100%), such that a value of 0.6 corresponds to 60%. The converter [12A] associated with the first battery [11A], labelled in the key as Power Controller Duty Cycle 2 and represented by a dashed line, is activated to a higher level (60%) to raise the voltage of the power output from the first battery [11A] which, as shown in [31], has a lower output voltage. The converter [12B] associated with the second battery [11B], labelled in the key as Power Controller Duty Cycle 1 and represented by a dashed line, is activated to a lower level (30%) since, as shown in [31 ], the second battery [11B] has a higher output voltage.

The activation level of the two power converters [12] changes in accordance with the changes in voltage as shown in the first graph [31]. Therefore, when the voltage of the second battery [11A] begins to rapidly fall after about 0.17 units of time, the activation level of its associated converter [12A] begins to rise more rapidly since it is necessary to boost the voltage more to maintain a constant output from the converter block [12] as a whole as shown in the second graph [32].

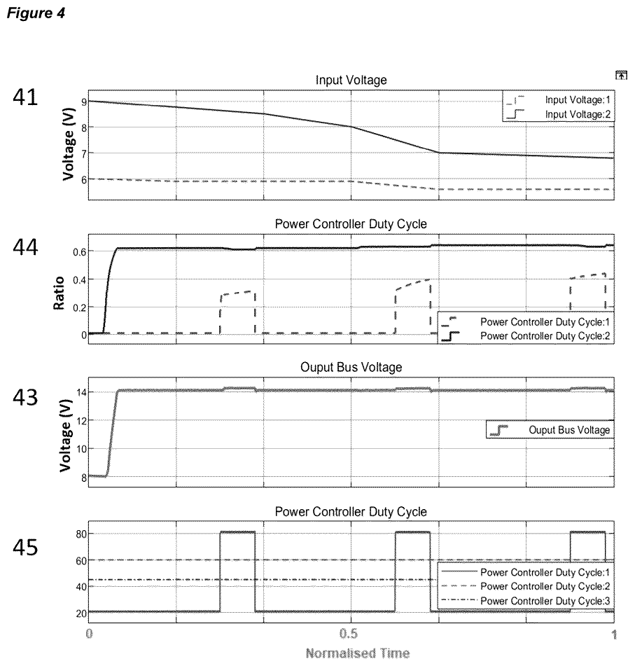

FIG. 4 shows data on a simulation for changes in demand affect the duty cycles of the power controllers as they draw from two batteries to maintain a consistent output voltage. The simulation is also carried out over a normalised time frame.

FIG. 4 shows a similar simulation to that shown in FIG. 3, with the same two simulated batteries [11A, 11B] that provide different and changing input voltages to the converters [12], as described with regard to the graph [31] in FIG. 3 and the graph [41] in FIG. 4. However, in this simulation the controller [15] is configured to select the battery [11] used with the goal of maximising efficiency based on the demand from the load [13]. FIG. 4 shows how changes in demand affect the duty cycles of the power controllers as they draw from two batteries to maintain a consistent output voltage.

The graph [41] shows the input voltage to the converters, i.e. the output voltage from the two batteries. The first voltage curve (indicated with a dashed line and labelled “Input Voltage: 1” in the key) shows the output from the first battery [11A]. The output voltage from the first battery [11A] is lower than the voltage output by the second battery [11B], which is indicated with a solid line and labelled “Input Voltage: 2” in the key. As the batteries are discharged to the load, the input voltages fall, as shown in the graph [41]. The batteries are discharged at different rates, as shown by the different slopes of the curves; the second battery [11B] is discharged more rapidly, as shown by the steeper curve in [41].

The graph [44] shows the activation of the two power converters [12]. The first power converter [12A] is associated with the first battery [11A]. The activation of the first power converter is shown in the graph with a dashed line and labelled as “Power Controller Duty Cycle: 1” in the key. The second power converter [12B] is associated with the second battery [11B]. The activation of the second power converter is shown in the graph with a solid line and labelled as “Power Controller Duty Cycle: 2” in the key.

The second power controller is activated at a consistent high level to maintain a base level of output (see the curve for the power controller duty cycle 2). This consistent draw produces the steeper fall in voltage shown in the first graph [41] for the second battery [11B]. When demand from the load spikes (see the graph [45]) and the power output would normally fall, the first power controller is activated to meet the demand of the load as shown by the spikes in the curve for the power controller duty cycle 1.

The graph [43] shows the voltage output by the power converters: a single output at a relatively consistent voltage is provided despite the changes in battery voltage shown in the graph [41] and the spikes in demand shown in the graph [45].

Accordingly, the system of the invention provides a constant power to the output despite variable load and multiple batteries, by selectively activating the power converters to optimise discharge of the batteries to the load.

The graph [45] shows the changes in demand from the load [13], together with the thresholds used to trigger the controller [15] to activate one battery (and the corresponding power converter). The thresholds are shown by the two dashed lines of which the upper threshold is labelled in the key as “Power Controller Duty Cycle: 2” and the lower threshold is labelled in the key as “Power Controller Duty Cycle: 3”. The demand is shown by the solid line labelled in the key as “Power Controller Duty Cycle: 1”.

When the demand crosses the upper threshold (shown by the dashed line), the controller triggers the first power converter [12A] to draw more power from the first battery [11A]; this is reflected by the spike in the activation of the first power converter [12A] shown in the second graph [44]. When the demand falls below the lower threshold (shown by the line comprising alternating dots and dashes) the activation of the first power converter [12A] is reduced, again as shown in the second graph [44].

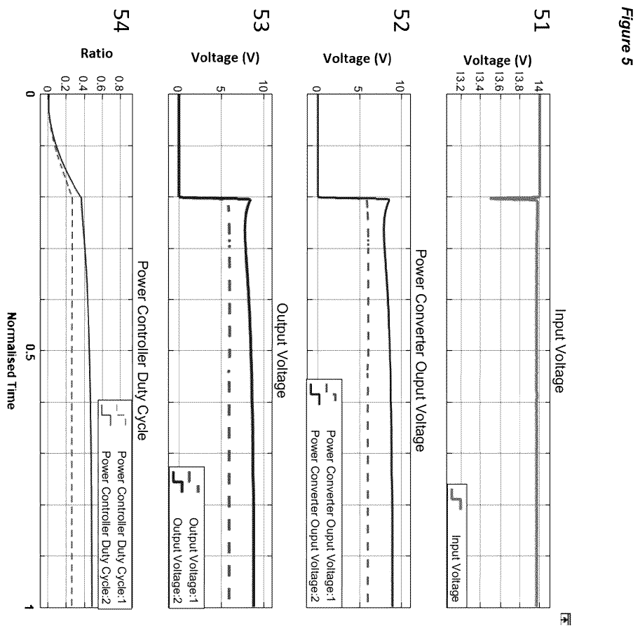

FIG. 5 shows the behaviour of the power converters [12] in the same simulated system with two batteries [11A, 11B] in charging mode. The simulation is carried out over a normalised time frame.

The first graph [51], titled “Input Voltage”, shows the power input from the power source [14] and to be provided to the batteries [11]. If this input power were passed directly to the batteries [11], it could cause damage and therefore it is beneficial to control it through the system of the invention. The controller [15] therefore determines the input voltage and signals the converters [12] to activate them to lower the input voltage. In this case, the activation of the converters [12] is shown in the fourth graph [54], titled “Power Controller Duty Cycle”, which shows that the converter [12A] associated with the first battery [11A], labelled in the key as “Power Controller Duty Cycle 1” and represented with a dashed line is activated to a lower level than the converter [12B] associated with the second battery [11B], labelled in the key as “Power Controller Duty Cycle 2” and represented with a solid line, since the first battery [11A] can be charged at a higher voltage than the second battery [11B].

The resulting output voltage from the converters [12] is shown in the second graph [52], titled “Power Converter Output Voltage”. The voltage output from the converter [12A] associated with the first battery [11A] is labelled in the key as Output Voltage 2 and represented by a solid line while the voltage output from the converter [12B] associated with the second battery [11B] is labelled in the key as Output Voltage 1 and represented by a dashed line. The voltages output from the converters [12] are then reflected in the voltage output by the system to the batteries [11] shown in the third graph [53], titled “Output Voltage” and graphically representing the outputs in the same way.

### Example Controller—Discharging

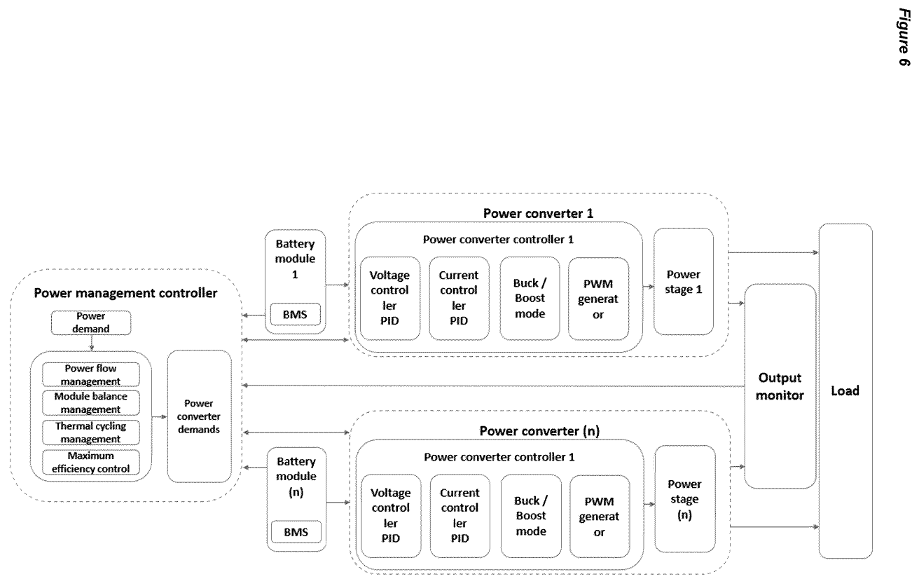

FIG. 6 is a representation of an example controller structure for a system including ‘n’ different batteries for discharging the n batteries to a load. The first battery is labelled battery module 1 and has an associated power converter 1. The nth battery is labelled battery module (n) and has an associated nth power converter labelled power converter (n). ‘n’ represents the number of battery modules. ‘n’ may be a number selected from 2 or more, 3 or more, 4 or more, 5 or more. ‘n’ may be from 2 to 10, preferably from 2 to 8, more preferably from 2 to 5, even more preferably from 2 to 3. In this way, the system includes 2 or more battery modules. The uses two strings including a battery module and power converter, but may contain any number of strings depending on the system requirements. The system also includes a power management controller and an output monitor.

The Battery module includes one or more electrochemical cells. The battery module may include a BMS which communicates with the power management controller. The BMS may only be a thermal sensor and/or voltage sensor, wherein the temperature and voltage information is provided to the controller which performs the function of a BMS.

The power converters are in electrical communication with the battery modules and the load. During discharge, power flows from the battery module through the power converter to the load. The power converters receive demands from the power management controller and then operate to control the output voltage and or output current according to the system demands.

The power converters typically include a voltage proportional integral derivative (PID) controller and a current PID controller. The PID is a control loop mechanism employing feedback that is widely used in circuits requiring continuously modulated control of voltage or current. The voltage PID and current PID allow the current and voltage to be controlled. The power converters also may include a buck or boost converter, such as a buck-boost converter. The buck converter is operable to step down or decrease the voltage. The boost converter is operable to step up or increase the voltage.

The power converters typically include a pulse width modulation (PWM) signal generator. The PWM generator operates on DC-DC current and outputs a pulse signal in order to activate another component of the power converter. For example, the PWM generator may output a pulse in order to activate the buck or boost converter. The pulse may open a switch (e.g. a FET) of the buck or boost converter.

The power converters typically include a switching device, referred to as the power stage. These are labelled as “Power stage 1” and “Power stage n” in FIG. 6. The power stage comprises a switch and a gate driver and controls the output from the power converter; the gate driver controls a switch which may allow a binary on/off output from the power converter at a duty cycle dictated by signalling from the controller. Thus, the switching device determines the activation of the power converter and therefore whether and when power is drawn from the battery connected to the power converter.

The power converter outputs power to a load. The power output to the load is measured by the output monitor. The output monitor reports the total output voltage and current to the power management controller. The controller may compare the power output measured by the output monitor to the power demand.

The system includes a controller, labelled the power management controller. The controller is the main supervisory controller which distributes power demands across each battery module based on the measured demand, and coordinates power flow during discharging. The controller is typically independent of a Battery Management System (BMS) controller.

The controller manages power flow to optimise efficiency of the system during discharge, limit thermal cycling of the battery and power converter and support changes in the power demand (e.g. respond to high peak loads). The controller has information about the different battery modules, such as their optimum discharge rates, temperatures, voltage, capacity, etc.

Information about the power demand is input into the controller, for example, from the load. The power demand information is used to determine the power flow management. The power flow management may alter the power converter voltage or current, and any buck/boost conversion to suit the power demand.

Information about the battery module balance is input into the controller. This may include the state of charge (SOC) of the different battery modules or the voltage of the different battery modules. The information may come from the battery or the BMS. The controller may consider the battery balance along with the power demand from the load. Typically, the controller aims to keep the SOC of the different batteries equal (e.g. to keep the batteries balanced). However, if the power demand is high then the controller may reduce the battery balance so that the high-rate battery modules are discharged more quickly to meet the high power demand. The controller may alter the power converter voltage, current, and any buck-boost conversion to keep the battery modules balanced.

Information about the thermal cycling management is also input into the controller. This information may include information about the temperature of the battery and/or the power converter. The information may come from the battery or the BMS. The controller may consider the temperature information along with the power demand from the load. Typically, the controller aims to keep the temperature of the battery within a predetermined range. The controller may also monitor the rate of change of the temperature of the battery, and aim to keep this within a predetermined range. The predetermined ranges may be determined by the battery and may depend on battery size, chemistry, thermal mass, energy density, SOC and cooling rate.

The controller may also include an efficiency control (labelled maximum efficiency control in FIG. 6). The efficiency control considers the information about power demand and determines the most efficient way to discharge the batteries to meet the demand. The efficiency control may also consider data on the power flow, battery balance and thermal cycle management, described above, when determining the most efficient way to discharge the batteries. For example, if power demand is low the efficiency control may preferentially discharge the battery having better low rate performance. On the other hand, if power demand is high the efficiency control may preferentially discharge the battery having better high rate performance.

### Example Controller—Charging

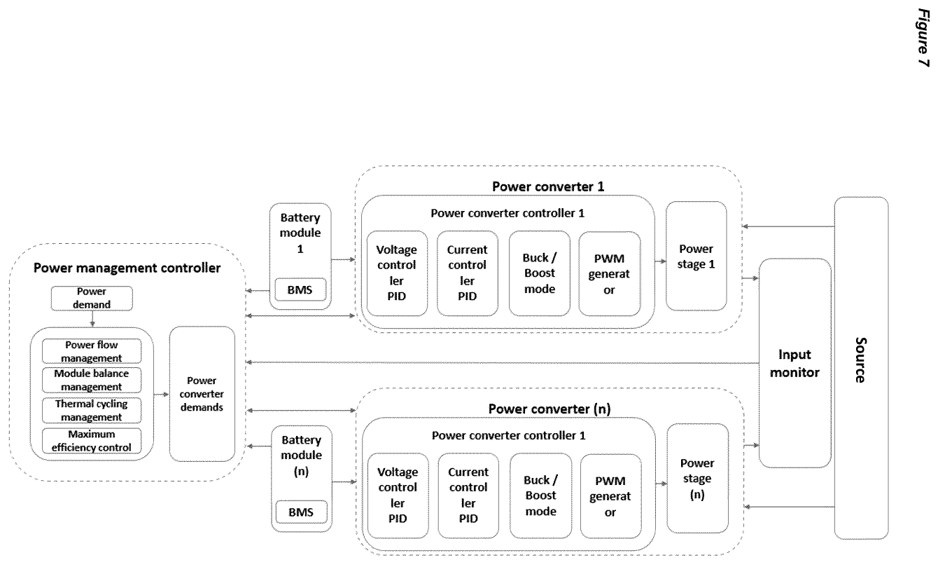

FIG. 7 is a representation of an example controller structure for a system including ‘n’ different batteries for charging the n batteries from a source. The system includes components described above for the Example discharge controller shown in FIG. 6. However, the batteries are charging from a source.

The battery module is as described above for FIG. 6.

The power converters are in electrical communication with the battery modules and the source. During charging, power flows from the source through the power converter to the battery modules. The power converters receive demands from the power management controller and then operate to control the input voltage and/or input current according to the system demands.

The power converters are as described above for FIG. 7.

The power converters typically include a switching device, referred to as the power stage. These are labelled as “Power stage 1” and “Power stage n” in FIG. 7. The power stage comprises a switch and a gate driver and controls the output from the power converter; the gate driver controls a switch which may allow a binary on/off output from the power converter at a duty cycle dictated by signalling from the controller. Thus, the switching device determines the activation of the power converter and therefore whether and when power is supplied to the battery connected to the power converter.

The power converter input power to the battery modules from a source. The power input to the power converter is measured by the input monitor. The input monitor reports the total input voltage and current to the power management controller. The controller may compare the power input measured by the output monitor to the power demand of the batteries.

The system includes a controller, labelled the power management controller. The controller is the main supervisory controller which distributes the input power across each of the battery modules based on the battery demand and the input power. The controller is typically independent of a Battery Management System (BMS) controller.

The controller manages power flow to optimise efficiency of the system during charging, limit thermal cycling of the battery and power converter and support changes in the power source supply (e.g. respond to peaks in supply). The controller has information about the different battery modules, such as their optimum charge rates, temperatures, voltage, capacity, etc.

Information about the power supply is input into the controller, for example, from the source. The power supply information is used to determine the power flow management. The power flow management may alter the power converter voltage or current, and any buck/boost conversion to suit the power source.

Information about the battery module balance is also input into the controller. This may include the state of charge (SOC) of the different battery modules or the voltage of the different battery modules. The information may come from the battery or the BMS. The controller may consider the battery balance along with the power supply from the source. Typically, the controller aims to keep the SOC of the different batteries equal (e.g. to keep the batteries balanced). However, if the power supply is high then the controller may reduce the battery balance so that the high-rate battery modules are charged preferentially to optimise use of the high power supply. Conversely, if the power supply is low then the controller may reduce the battery balance so that the low-rate battery modules are charged preferentially, to improve the cell cycling efficiency and/or longevity of the battery modules. The controller may also alter the power converter voltage, current, and any buck-boost conversion to keep the battery modules balanced.

Information about the thermal cycling management is also input into the controller. This information may include information about the temperature of the battery and/or the power converter. The information may come from the battery or the BMS. The controller may consider the temperature information along with information about the power supply from the source. Typically, the controller aims to keep the temperature of the battery within a predetermined range. The controller may also monitor the rate of change of the temperature of the battery, and aims to keep this within a predetermined range. The predetermined ranges may be determined by the battery and may depend on battery size, chemistry, thermal mass, energy density, SOC and cooling rate.

The controller may also include an efficiency control (labelled maximum efficiency control in FIG. 7). The efficiency control considers the information about power supply from the source and determines the most efficient way to charge the batteries from the source. The efficiency control may also consider data on the power flow, battery balance and thermal cycle management, described above, when determining the most efficient way to charge the batteries. For example, if power supply is low the efficiency control may preferentially charge the battery having better low rate performance. On the other hand, if power supply is high the efficiency control may preferentially charge the battery having better high rate performance.

### Additional Example Controller—Balancing During Discharging

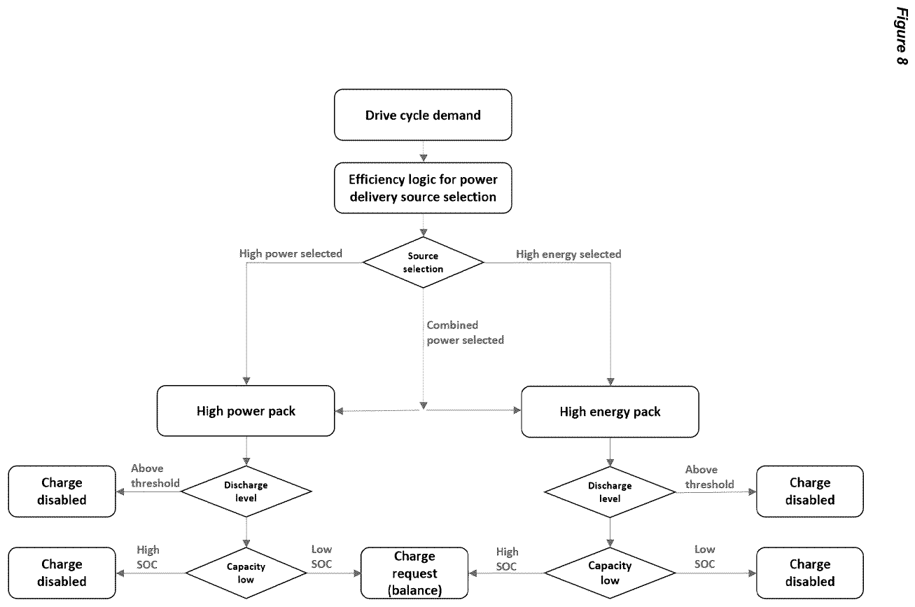

FIG. 8 shows a flowchart of an example control algorithm for controlling the power converters to adjust the rate of discharge of the two or more batteries, including wherein the batteries are balanced by actively transferring power between the batteries or by adjusting the power transfer to the load.

The example system includes a high-rate battery (high power pack) and a low-rate, high-capacity battery (high energy pack). The high-rate and low-rate batteries are in electrical connection with a load via power converters configured to adjust the current and voltage for the different batteries, as illustrated in FIG. 1. In addition, the high-rate and low-rate batteries are in electrical communication, to allow for power transfer between the batteries.

First, the drive cycle demand is determined, based on the demand of the load. The controller then determines which of the high-rate and/or low-rate batteries are discharged for the most efficient constant power delivery to the load. The controller may select the high-rate batteries (high power selected branch), the low-rate batteries (high energy selected branch) or both the high-rate and low-rate batteries (combined power selected branch) depending on the demand of the load.

When the controller selects the high-rate (high power) batteries for discharge, the controller signals to the power converter to transfer power from the high-rate batteries to the load. The power converter controls the rate of power transfer (the ‘discharge level’) from the high-rate batteries to the load as described for the example system above.

When the controller selects the low-rate (high energy) batteries for discharge, the controller signals to the power converter to transfer power from the low-rate batteries to the load. The power converter controls the rate of power transfer (the ‘discharge level’) from the low-rate batteries to the load as described for the example system above.

The controller also functions to balance the high-rate and low-rate batteries. The controller monitors the rate of power flow from the high-rate and/or low-rate batteries to the load (the ‘discharge level’). When the discharge level of the high-rate batteries and/or the low-rate batteries is above a threshold level the option to transfer or receiver charge from other batteries in the system is disabled (‘charge disabled’). The threshold level is a calibrated limit, specific to each of the two or more different batteries, at which point the current draw from the system is out of range (i.e. the current draw is too high to supplement charging the other battery in the system).

However, when the discharge level of the high-rate batteries and/or the low-rate batteries is below the threshold level, the high-rate batteries have the ability to transfer or receive charge from other batteries in the system, in order to provide a balancing effect.

In this case, the controller determine the capacity of the high-rate battery. If the high-rate battery is at a high SOC (e.g., a SOC of more than 50%) then the option to transfer or receive power from the other batteries in the system is disabled (‘charge disabled’). If the low-rate battery is at a low SOC (e.g., a SOC of 50% or less) then the option to transfer or receive power from the other batteries in the system is disabled (‘charge disabled’).

On the other hand, if the high-rate battery is at a low SOC (e.g., a SOC of less than 50%) and the low-rate battery is at a high SOC (e.g., a SOC of more than 50%) then a charge balance request is signalled by the controller.

The controller signals to balance the batteries by transferring power from the low-rate, high-energy batteries having a high SOC to the high-rate batteries having a low SOC to balance the SOC of the batteries. The controller continues to monitor the capacity of the batteries. Once the capacity of the batteries are similar, the controller signals to stop transferring power between the batteries.

Balancing may also occur in the same way when combined power is selected, as the rate of power transfer from the high-rate battery and low-rate battery provided to the load is adjusted to control the relative SOC of the high-rate battery and the low-rate battery.

The balancing occurs when the high-rate battery is at a low SOC and the low-rate battery is at a high SOC. The balancing results in the high-rate battery having a relatively high SOC, so that they system can meet high-rate demands from a load. This may be useful where a high peak power may be required by the load from the system.

In alternative examples, the high-rate and low-rate batteries may be reversed. Thus, balancing occurs when the high-rate battery is at a high SOC and the low-rate battery is at a low SOC. The balancing results in the high-rate battery having a relatively low SOC, and the low-rate battery having higher SOC, as excess energy is transferred from the high-rate battery to the low-rate battery. This alternative system can accept high-rate power provided from a source. This may be useful where a high peak power may be provided to the system from a source (e.g., a regenerative braking system, renewable energy generator).

### Additional Example Controller—Balancing During Charging

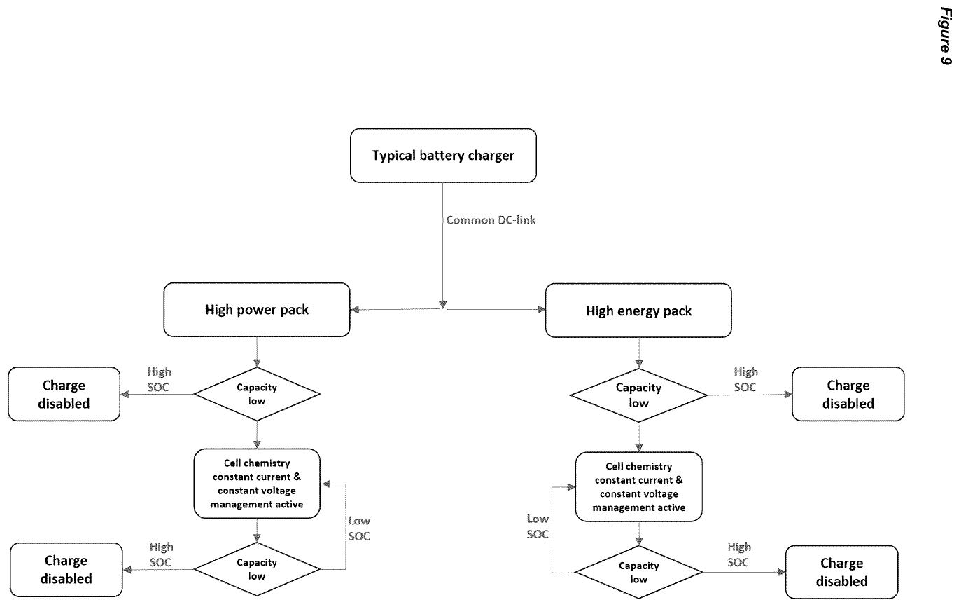

FIG. 9 shows a flowchart of an example control algorithm for controlling the power converters to adjust the rate of charge of the two or more batteries including wherein the batteries are balanced by adjusting the power transferred to the batteries from the source.

The example system includes a high-rate battery (high power pack) and a low-rate, high capacity battery (high energy pack). The high-rate and low-rate batteries are in electrical connection with a source (typical battery charger) via power converters configured to adjust the current and voltage for the different batteries, as illustrated in FIG. 1. In addition, the high-rate and low-rate batteries are in electrical communication, to allow for power transfer between the batteries. The high-rate and low-rate batteries are connected by a common DC-link, Once the charger is connected to the system, the controller determines which of the high-rate and/or low-rate batteries are charged from the power provided by the source. The controller may select the high-rate batteries (high power selected branch), the low-rate batteries (high energy selected branch) or both the high-rate and low-rate batteries (combined power selected branch) depending on the rate of power supplied by the source.

For the high-rate (high power) batteries, the controller signals to the power converter transfer power to the high-rate batteries from the source. The power converter controls the rate of power transfer as described above.

The controller monitors the capacity of the high-rate batteries. If the high-rate battery is at a high SOC (e.g., above a threshold, such as a SOC of 80%) then charging is disabled. If the high-rate battery is at a low SOC (e.g., below a threshold, such as SOC of 80%) then the controller adjusts the power transfer to provide a constant power transfer while maintaining the battery conditions (see “cell chemistry constant current & constant voltage management active” step).

The controller continues to monitor the capacity of the high-rate batteries. If the high-rate battery reaches a high SOC (e.g., above a threshold, such as a SOC of 80%) then charging is disabled. If the high-rate battery is at a low SOC then the controller continues to provide a constant power transfer while maintaining the battery conditions.

The same process is followed for the low-rate (high energy) batteries. The controller monitors the capacity of the high-rate batteries. If the high-rate battery reaches a high SOC (e.g., above a threshold, such as a SOC of 80%) then charging is disabled. If the high-rate battery is at a low SOC then the controller continues to provide a constant power transfer while maintaining the battery conditions (see “cell chemistry constant current & constant voltage management active” step).

Balancing of the batteries occurs during charging as the rate of power transfer to the high-rate battery and low-rate battery from the source is adjusted to control the relative SOC of the high-rate battery and the low-rate battery. Charging of the high-rate battery may be disabled at a certain SOC, and so the low-rate battery receives a higher rate of power transfer. Alternatively, charging of the low-rate battery may be disabled at a certain SOC, and so the high-rate battery then receives a higher rate of power transfer. In this way, the charging results in a balanced SOC for the high-rate and low-rate battery.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### REFERENCES

A number of publications are cited above in order to more fully describe and disclose the invention and the state of the art to which the invention pertains. Full citations for these references are provided below. The entirety of each of these references is incorporated herein.
WO2019/234248
WO2015/016965
US 2005/0194937
US 2004/0169489
US 2006/0028178
WO2016/054368
WO2016/054359
WO2020/086946

1. A system for discharging multiple batteries to a load, or charging multiple batteries from a source, the system comprising:
two or more batteries wherein two of the batteries have one or more different aspects;
a power connector for electrically connecting the batteries to a load or a source;
a power converter in electrical communication with the batteries and the power connector, wherein the power converter is for independently controlling the rate of discharge or charge of each of the batteries; and
a controller in communication with the batteries and the power converter, wherein the controller is for adjusting the rate of discharge or charge of the batteries in response to data receivable from the batteries, for providing a constant power from the batteries to the load, or from the source to the batteries.

2. The system of claim 1 wherein two of the batteries have one or more different aspects selected from the list consisting of electrical properties, chemical properties, physical properties or structural properties.

3. The system of claim 2, wherein:
the different electrical properties include different discharge voltage profile, charge voltage profile or cell voltage at the same state of charge (SOC);
the different chemical properties include different electrode material or charge carrier;
the different physical properties include different cell degradation levels or cycling conditions; and
the different structural properties include different electrode morphology, electrode active material particle size or electrode specific surface area.

4. The system of claim 1, wherein the two or more batteries comprise a low-rate battery and a high-rate battery, wherein the low-rate battery has a lower maximum operable discharge and/or lower maximum operable charge rate than the high-rate battery.

5. (canceled)

6. The system of claim 4, wherein the high-rate battery is a battery having a maximum operable charge and/or discharge rate of 5 C or more.

7. The system of claim 4, wherein the low-rate battery is a battery having a maximum operable charge and/or discharge rate of 5 C or less.

8. (canceled)

9. (canceled)

10. The system of claim 1, wherein at least one of the batteries is a battery comprising a working electrode active material comprising a niobium-containing metal oxide.

11. (canceled)

12. (canceled)

13. The system of claim 10, wherein the niobium-containing metal oxide is Nb₁₆W₅O₅₅ or Nb₁₈W₁₆O₉₃.

14. The system claim 1, wherein the power converter comprises:
(i) a buck converter, a boost converter or a buck-boost converter; and/or
(ii) a voltage proportional integral derivative controller and/or a current proportional integral derivative controller; and/or
(iii) a pulse width modulation signal generator, operable to activate a buck, boost or buck-boost converter.

15. The system of claims 1, wherein the power converter is bidirectional.

16. The system of claim 1, wherein the power converter includes an input monitor for measuring the power input and/or an output monitor for measuring the power output from the power converter.

17. The system of claim 1, wherein the constant power from the batteries to the load, or from the source to the batteries, is a power which differs by ±20% or less from a mean power taken over an operation period of the system.

18. The system of claim 1, wherein the system is operable to simultaneously discharge or simultaneously charge the batteries.

19. The system of claim 1, wherein the controller is for receiving data from the batteries, which data comprises battery voltage, battery current, and battery temperature.

20. (canceled)

21. The system of claim 1, wherein the controller is for balancing the batteries by independently adjusting the discharge or charge rate of the two or more of the batteries.

22. The system of claim 1, wherein the two or more batteries are electrically connected, and the controller is for balancing the batteries transferring power between the two or more batteries.

23. The system of claim 1, wherein the controller is for balancing the batteries such that the two or more batteries have substantially the same state of charge.

24. A method of discharging multiple batteries to a load, or charging multiple batteries from a source, using a system comprising:
two or more batteries wherein two of the batteries have one or more different aspects;
a power connector electrically connecting the batteries to the load or the source;
a power converter in electrical communication with the batteries and the power connector, wherein the power converter independently controls the rate of discharge or charge of each of the batteries; and
a controller in communication with the batteries and the power converter, and the method comprising the steps of:
discharging the batteries to the load, or charging the batteries from the source, using the power converter and power connector,
sending data on the condition of the batteries to the controller, and
adjusting the discharge rate or the charge rate of the batteries in response to the data from the batteries, to provide a constant power from the batteries to the load or from the source to the batteries.

25. The method of claim 24 wherein adjusting the discharge rate or the charge rate of the batteries in response to the data from the batteries comprises the steps of:
(i) receiving data on the power demand of the load or the power supply from the source;
(ii) receiving data on the condition of the batteries;
(iii) determining which of the batteries can supply power to the load or can receive power from the source based on the data on the condition of the batteries;
(iv) adjusting the rate of discharge or rate of charge of the batteries to provide a constant power from the batteries to the load or from the source to the batteries;
(v) repeating steps (i)-(iv) until the controller signals the power converter to stop discharging or charging the batteries.

26. (canceled)

27. (canceled)

28. The method of claim 24, further comprising a step of
balancing the batteries by independently adjusting the discharge or charge rate of the two or more of the batteries using the controller; and/or
balancing the batteries by transferring power between the two or more batteries, wherein the two or more batteries are electrically connected.

29. (canceled)
